(19) United States
(12) Patent Application Publication
(10) Pub. No.: US 2008/0270889 A1
(43) Pub. Date: Oct. 30, 2008

(54) DYNAMIC IMAGE AND TEXT CREATION FOR ONLINE BOOK CREATION SYSTEM

(75) Inventor: Jeff Slosar, Henderson, NV (US)

Correspondence Address: HOWISON & ARNOTT, L.L.P, P.O. BOX 741715, DALLAS, TX, 75374-1715, US

(73) Assignee: BOOKLAB, INC., HENDERSON, NV (US)

(21) Appl. No.: 12/110,811

(22) Filed: Apr. 28, 2008

Related U.S. Application Data
(60) Provisional application No. 60/914,201, filed on Apr. 26, 2007.
(60) Provisional application No. 60/914,206, filed on Apr. 26, 2007.
(60) Provisional application No. 60/914,197, filed on Apr. 26, 2007.
(60) Provisional application No. 60/914,210, filed on Apr. 26, 2007.

(51) Int. Cl. G06F 17/24

(52) U.S. Cl. 715/235

(57) ABSTRACT

A method for dynamically editing a publication involves selecting a publication template from a plurality of publication templates, wherein said publication template includes a plurality of publication attributes. The publication is displayed in a graphical user interface responsive to the selected publication template. A selected group of the plurality of publication attributes is displayed via the graphical user interface. Inputs are received selecting particular entries for the selected group of the plurality of the publication attributes. The particular entries are applied to each of the associated publication attributes of the publication template. The display of the publication is updated to reflect the particular entries in the graphical user interface in real time.

### CROSS-REFERENCE TO RELATED APPLICATIONS

This application claims benefit of U.S. Application Ser. No. 60/914,206, filed Apr. 26, 2007, and entitled ONLINE BOOK EDITOR (Atty. Dkt. No. BOOK-28,287), U.S. Application Ser. No. 60/914,197, filed Apr. 26, 2007, and entitled ONLINE BOOK SELECTION WIZARD (Atty. Dkt. No. BOOK-28,285), U.S. Application Ser. No. 60/914,201, filed Apr. 26, 2007, and entitled DYNAMIC IMAGE AND TEXT CREATION FOR ONLINE BOOK CREATION SYSTEM (Atty. Dkt. No. BOOK-28,286) and U.S. Application Ser. No. 60/914,210, filed Apr. 26, 2007, and entitled METHOD FOR TEMPLATE CREATION FOR ONLINE BOOK CREATION SYSTEM (Atty Dkt. No. BOOK-28,288), which are each incorporated herein by reference.

### TECHNICAL FIELD

The present invention relates to creation of books, and more particularly, to a method for dynamically updating images and text in an online book publication process.

### BACKGROUND

Book publication in the past has been a drawn out and complicated processes that required an individual to obtain some type of agreement for publication with a well known publishing entity. This would then enable the large scale publication of books. On a smaller scale, individuals will often create their own personal publication for a limited run situation including only one or a few books using for example or local copying or publication entity such as Kinko's.

The creation of a PC based software such as Microsoft Publisher® and others have enabled individuals to create their own book publications on a limited basis by using the software and a PC based environment. However, in order to utilize the software for creating the book publications is required that the user become versed in the operation of the software which may involve a long learning curve in order to utilize all the functionalities desired to make a book publication that will satisfy the user.

Family members often desire to create a novelty item that will enable the creation of a personalized item that may be provided to an individual that is personalized to them in some fashion. Similar examples of this would include picture calendars wherein the calendars in the picture section include personalized photos of an individual or a family, and calendars having date portions including specific dates relevant to the individual such as their birthdays, anniversaries, etc. Creation of these types of personalized items in the book publication realm are much more difficult due to the expense involved with larger publication entities or the complexity involved with the creation of self publish items utilizing publication software in a PC based environment.

Thus, there exists a need for an individual that desires to publish a limited run book publication that does not require the user to become well versed in the operation of a complicated software program or require the user to utilize a more expensive process going through a normal publication house or local publishing entity that requires a great deal of time and energy.

### SUMMARY

The present invention, as disclosed and described herein, comprises a method for dynamically editing a publication. The method comprises a step of selecting a publication template from a plurality of publication templates. The publication template includes a plurality of publication attributes. The publication is displayed in a graphical user interface responsive to the selected publication template. A selected group of the plurality of publication attributes is displayed through the graphical user interface and a number of inputs are received selecting particular entries for the selected group of the plurality of publication attributes. The particular entries for the associated publication attributes of the publication template are applied to each occurrence of associated publication attributes within the publication template. The display of the publication is then updated to reflect the particular entries in the publication in the graphical user interface in real time.

### BRIEF DESCRIPTION OF THE DRAWINGS

For a more complete understanding, reference is now made to the following description taken in conjunction with the accompanying Drawings in which:

FIG. 1 illustrates the operating environment of the book editor of the present disclosure;

FIG. 2 illustrates an alternate operating environment for the book editor of the present disclosure;

FIG. 3 is a functional block diagram, illustrating the various components of the book editor;

FIG. 4 illustrates the main editing page of the graphical user interface;

FIG. 5 illustrates the quick and easy edit window of the graphical user interface;

FIG. 6a illustrates a first page view of a book edited according to a first group attributes;

FIG. 6b illustrates an alternative view of the pages in 6a, using an alternative set of attributes;

FIG. 7 illustrates a coloring book view of a book being edited;

FIG. 8a is a functional block diagram of the dynamic image and creation process functionality;

FIG. 8b is a flow diagram describing the dynamic image and text creation process;

FIG. 9 illustrates the graphical user interface of the change book size window;

FIG. 10 illustrates the graphical user interface of the resize options window;

FIG. 11 illustrates the manner in which the graphical user interface may be used to edit text;

FIG. 12 illustrates the graphical user interface for the upload images window;

FIG. 13 illustrates the graphical user interface including the image guide menu;

FIG. 14 illustrates the graphical user interface including the photo flow settings window;

FIG. 15 illustrates the menu within the graphical user interface enabling manipulation of images;

FIG. 16 illustrates additional image menu items enabling manipulation of images within a book template;

FIG. 17 illustrates the graphical user interface of the preserve changes window;

FIG. 18 illustrates the graphical user interface enabling changes to the cover of the book;

FIG. 19 illustrates a graphical user interface of the window enabling changes to pages of a book;

FIG. 20a illustrates the graphical user interface of the page border option window;

FIG. 20b illustrates a page including a selected page border option;

FIG. 21 illustrates the graphical user interface enabling a user to change page colors of a publication template;

FIG. 22 illustrates the graphical user interface enabling a user to control a page layout;

FIG. 23 illustrates the graphical user interface enabling insertion of pages within the book;

FIG. 24 illustrates the graphical user interface to confirm deletion of pages from a book;

FIG. 25 illustrates the graphical user interface enabling control of text font within a book editor;

FIG. 26 illustrates the graphical user interface enabling saving of a created book template;

FIG. 27 illustrates the graphical user interface enabling publication of a created book template; and

FIG. 28 is a flow diagram describing the operation of the book editor of the present disclosure.

### DETAILED DESCRIPTION

Referring now to the drawings, wherein like reference numbers are used herein to designate like elements throughout, the various views and embodiments of a dynamic image and text creation for online book creation system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

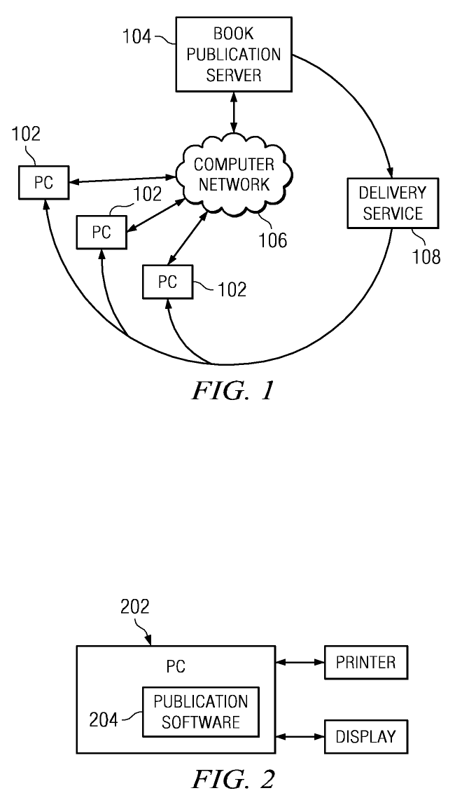

Referring now to FIG. 1, there is illustrated a general block diagram of the manner in which an individual may create an online book publication according to the system and method of the present invention. In the operating environment of the present disclosure, a plurality of individual personal computer units 102 which are remotely located from a book publication server 104 are able to communicate with the book publication server 104 over a computer network 106 such as the internet. Using interactions between the book publication server 104 and the PCs 102 over the computer network 106, a user defined book for publication is created on the book publication server 104. Once the book has been created on the book publication server 104 and paid for by the individual utilizing the PC 102 in interaction with the server 104, this personalized book publication may then be provided to the user at the PC 102 via some type of delivery surface 108. The delivery surface may comprise the U.S. Postal Service, UPS, FedEx, etc. Using this system and method, a user located at the PC 102 may create one or more copies of a personalized book publication upon the publication server 104 and pay for these on a per unit basis such that they may then be delivered to the user and given as gifts or kept for personal use.

With the online book editor, no installation of software is required on the users system 102. The system enables the use of “Cloud Computing” or Saas (Software as a Service) applications. Rather than installing the software on the users system 102, the application software exists on servers 104 that the user accesses from any internet-connected system. This structure enables: 1) elimination of the opportunity of viral infection of the user's system, 2) saving of files on the servers 104 removing the need for the user to store files on their system and to backup their work, and 3) easy collaboration—users can jointly create books without having to send large files back and forth. For instance, in the creation of a cookbook, each of the collaborators can submit their recipes online without sending files back and forth. The master book exists on the server. This type of system provides a number of advantages over a locally implemented software based system.

Referring now also to FIG. 2, rather then implementing the system and method on a book publication server 104 as envisioned in the preferred environment, the book publication software and editor described herein may also be implemented upon a PC 202 within publication software 204 implemented within the PC in a conventional manner.

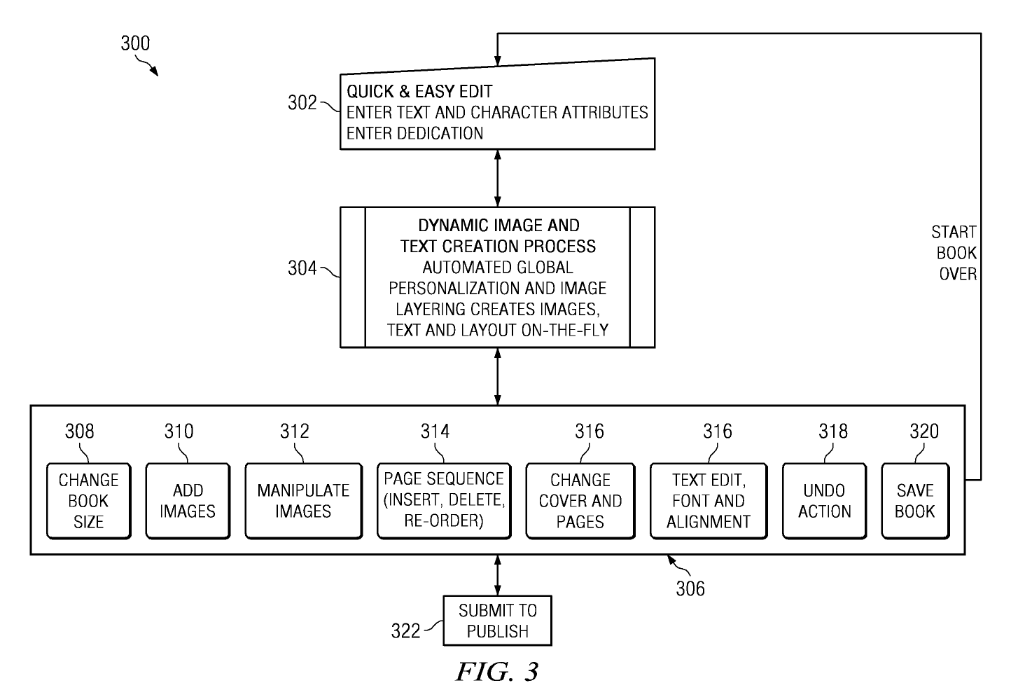

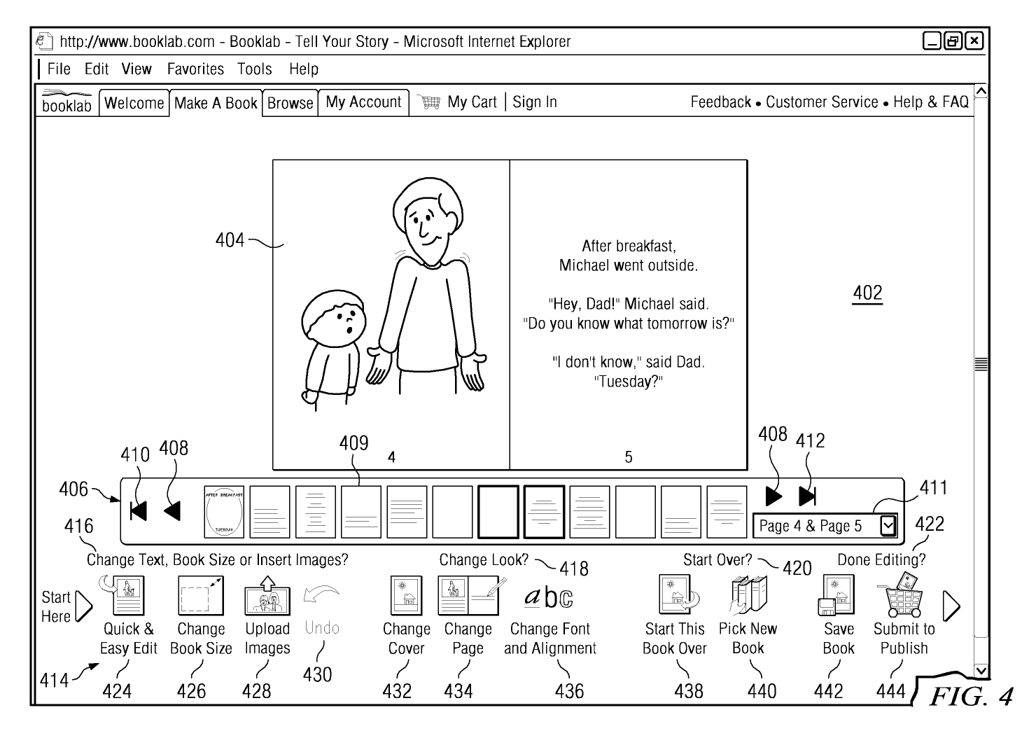

Referring now to FIG. 3, there is illustrated a block diagram describing the general functionalities of the online book editing system 300 of the present disclosure. The quick and easy edit function 302 enables a user to enter generalized text and character attributes for use in a story template. This process involves the user filling out information with respect to predetermined attributes as will be discussed herein below and these attributes are interpreted by the system 300 in order to insert them within the story template that is being utilized. Responsive to the quick and easy edit information provided at function 302 a dynamic image and text creation functionality process 304 utilizes the information provided from module 302 in order to automatically perform a global personalization process with respect to the information that was entered at module 302 in order to create a personalized book publication. This process involves the creation of images, text and book layout in an on-the-fly real time manner responsive to the information that was entered to the quick and easy edit module 302.

Once the generalized book publication format has been created from the selected information and the quick and easy edit information 302 by the dynamic image and text creation process 304, a number of more specific editing functionalities 306 may be used to more specifically configure the personalized book publication in a desired manner. Each of these editing functionalities 306 will be more specifically described herein below. The change book size functionality 308 enables the user to specify which of a number of predetermined book sizes may be used within the selected book publication. These selection options may range from children's books, to coffee table books, to hardback books, etc. The add images functionality 310 enables a user to substitute their own images for images that are pregenerated and stored within the book template that has been selected by the user. As will be discussed herein below the only limitations with respect to these images may relate to certain resolution requirements that are recommended with respect to images that are inserted into a selected image area. The manipulate images functionality 312 enables a user to alter images that have been downloaded into a created book. This may involve cropping the images, increasing its size to fit a particular template, rotating the image etc. The page sequence functionality 314 enables a user to alter the predetermined page order that has been established according to a generated book template. This may enable a user to insert pages into the book, delete pages from the book or alter the order of the pages that are already in the book.

The change cover and pages functionality 316 enables a user to alter the format or look of both the cover and pages of a user personalized book. This can involve changing the coloring and format of text and information on the front cover of the book or altering the borders or font used on particular pages of the book. The text edit font alignment functionality 316 enables the user to alter the look and configuration of text upon a particular page. The user can change the way that the text looks upon the page and may also change its alignment within the page. Alternatively, the user can add or delete text from the book in order to have information read in a more particularly desired manner according to their personalized book creation.

The undo action functionality 318 enables a user to undo any particular action that has previously been added to a personalized book publication that is being created. The undo action functionality 318 will take back the state of the personalized book publication to a previous level before a most recent change or back to the original level before any changes or edits were made. Finally, the save book functionality 320 enables a user to save the personalized book publication that has been created using the online book editing functionality 300 described herein above. Once this information has been saved by the user, it is stored in a particular location and the book publication is then available for the submit to publish functionality 322 which enables the user to submit the book for being created in hard copy form and transmitted to a desired location.

Referring now to FIG. 4, there is illustrated a graphical user interface of the main book editor 402 through which a user may create their personalized book copy. The editor 402 is accessed once a particular book template has been selected by the user. The template establishes a default version of the story. The book template can be associated with a particular kind of story and would include a precreated storyline which may be altered through the online book editor 402. The templates may also be blank enabling all of the content to be originally created by the user or only include a limited amount of material such as a single page to give the user a very general shell. The online book editor 402 includes a page window 404 which displays a view of up two pages of the book that is being created. In the example of FIG. 4, a first side of the page window 404 includes an illustration of a man speaking with a boy. On the second side of the page window 404 is text associated with the illustration.

The thumbnail navigator 406 enables a user to go to any particular page of the book. The thumbnail navigator 406 includes navigation arrows 408 which enable a user to page forward or page backward to the next set of two pages within the page viewer 404. A beginning arrow 410 enables the user to jump back to the beginning pages of the book and the ending arrow 412 enables the user to jump to the last two pages of the created book.

The thumbnail menu 406 additionally includes a number of thumbnail pictures 409 representing the individual pages of a book. A user may navigate to any particular page by clicking on the thumbnail 409 of the page within the thumbnail navigation menu 406. A user may additionally navigate through the thumbnail navigation menu 406 via the page number window 411. The page number window 411 provides a drop down menu enabling a user to select a particular pair of pages to be displayed within the page viewer 404.

The editing menu 414 runs along the bottom portion of the screen below the thumbnail navigator 406. The editing menu 414 includes a change text, book size or insert images section 416 enabling a user to change the text, book size or images contained within the book. The change look section 418 enables the user to modify the general appearance of the book that has been created by changing the cover, pages or changing font within the book. The start over section 420 enables a user to begin anew with the personalized book that is being created. Finally, the done editing section 422 enables a user to either save or publish the book that has been created.

The change text, book size or insert images section 416 includes the quick and easy edit icon 424. This icon 424 provides access to the quick and easy edit functionality 302 and enables a user to establish general parameters for insertion into the book that they are creating. The change book size icon 426 is associated with the change book size functionality 308. This enables the user to size the book according to desired parameters. The upload images icon 428 is associated with the add images functionality 310 enabling a user to insert particular images within their book in place of the illustrations that are according to the book template selected. The undo icon 430 is associated with the undo action functionality 318 enabling a user to go back to an earlier generated state of the book that is being created.

The change look section 418 includes the change cover icon 432 which is associated with the change cover and pages functionality 316. This icon 432 enables user access to the parameters for changing the appearance of the cover of the book. The change page icon 434 is also associated with the change cover and pages functionality 316 and enables the user to configure the look of the pages of the book in a desired manner. The change font and alignment functionality 436 is associated with the text edit and font alignment functionality 316 and enables a user to change the look of font of the text within the pages of the book and the alignment of the text within the book.

The start over section 420 includes the start this book over icon 432 directing a user back to the quick and easy edit function 302 which is utilized to start the personalized book creation process. The pick new book icon 440 enables the user to select a different book template for use by the user and then editing by the quick and easy edit function 302. The done editing section 422 includes the save book icon 422 associated with the save book functionality 320 enabling the user to save the contents of the personalized book that they have created using the online text editor. The submit to publish icon 444 enables the user to utilize the submit to publish functionality 322 in order to pay for and publish the book that they have been created and have a hard copy forwarded to a desired location.

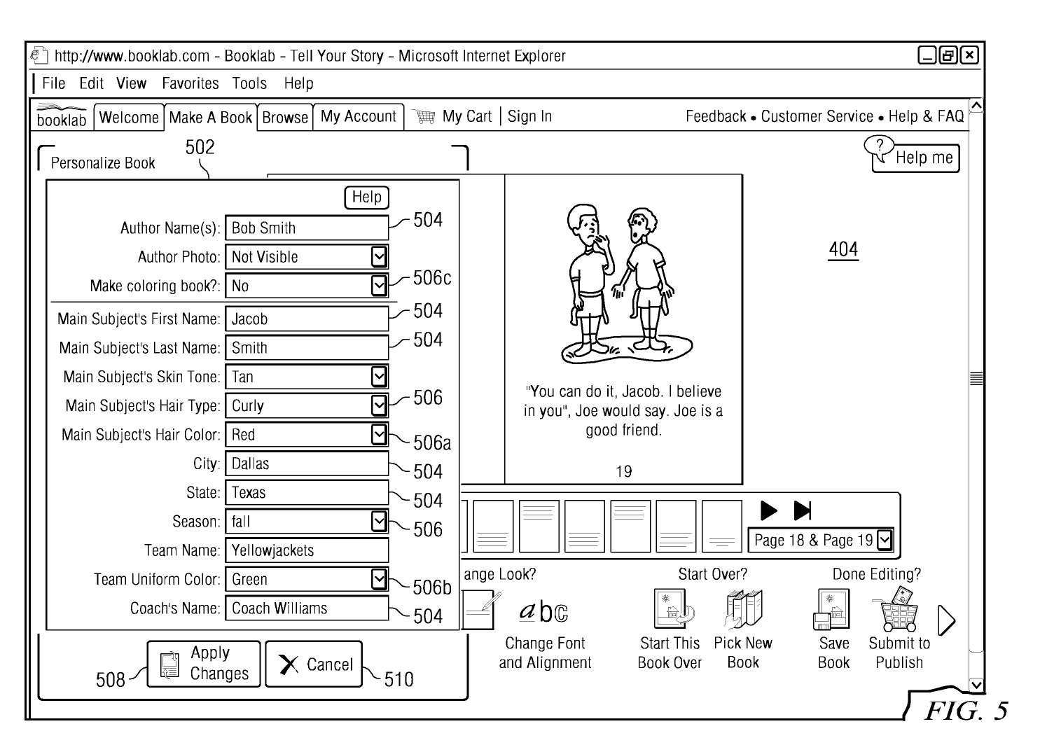

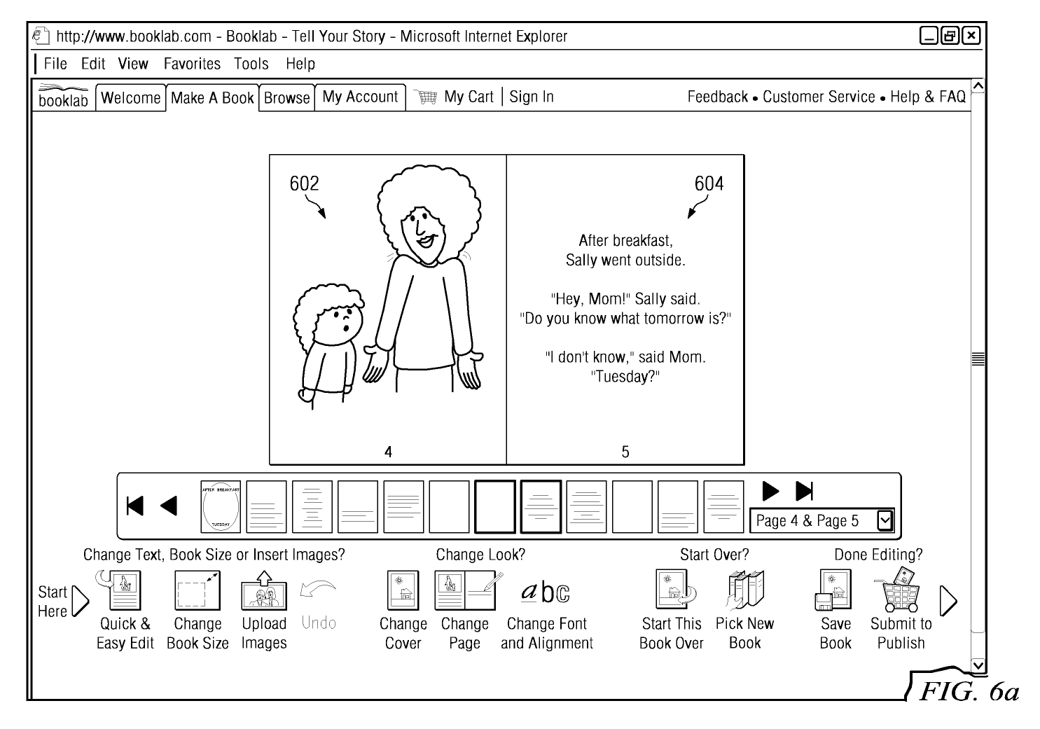

Once an initial book template has been selected by a user for creation of a personalized book the text editor main page 402 is open. However, initially the only icon which is available for activation by the user within the editing menu 414 is the quick and easy edit icon 424. The remainder of the icons within the editor menu 414 are grayed out and unable to be accessed by the user until the data fields within the quick and easy edit function 424 are selected. Once the quick and easy icon 424 is selected, the personalize book window 502 as shown in FIG. 5 overlays the editor screen 404. The personalized book window 502 includes a number of data fields that may be filled in by the user. The custom word data fields 504 in addition to including individual words may be configured to except a phrase or could be configured to enable a user to insert a dedication to the recipient of the book or to provide a summary of the contents of the book that is being provided. The custom word data fields 504 include customizable data fields. These fields are freeform and may have any text string placed therein. These typically only alter text changes within the template. Custom word list data fields 506 comprise data fields that have drop down menus associated therewith that enable a user to select one of a limited number of selections of the text strings or options. The drop down menus may affect both text and images within the template.

Once all of the desired information has been presented into the personalized book window 502, the user may click on the apply changes button 508. This will cause the editor to review the information that has been entered into the data fields on the personalized book page 502 and using the dynamic image and text creation functionality 304 insert the information entered into the data fields of the personalized book window 502 into predefined locations within the book template that are associated with the data fields. The information may be inserted into a “one-to-one” relationship or a “one-to-many” relationship. For instance, a user may choose an entry “Home State” from a dropdown and this choice ripples through making the change to any thing coded with a <homestate> within the template. This is a “one-to-one” relationship. However, a user may also select the main character to be “male”. This choice, can ripple through and make changes to all sorts of grammar-base fields, such as, subject pronoun, object pronouns, possessive pronouns, reflexive, (him, his, himself) etc. and not just where the word coded word for <gender> is located in the book. This is a “one-to-many” relationship.

Thus, in the example provided in FIG. 5, the dynamic image and text creation process functionality 304 would determine that the data field “main subject first name” had been entered as “Jacob”. The functionality 304 will then search through the book template and locate each occurrence were the “main subject first name” is to be inserted. The functionality 304 inserts the name “Jacob” into each of these locations. A similar process would occur for each of the other data field entries within the personalized book window 502. Rather then applying all of the changes that were entered in the personalized book window 502, the user may click on the cancel button 510 to cancel all the entries and leave the book in its default format.

In addition to inserting particular text strings within the book template, different illustrations can be created responsive to information entered within the personalized book window 502. For example, the data field 506a indicates that the “main subject hair color” is “red”. Additionally, the data field 506b indicates that the “team uniform's color” is “green”. Whichever colors are selected from the associated drop down menus are noted from the personalized book window 502 by the dynamic image and text creation process functionality 304 and the image layers associated with the selected attributes are pulled from a memory associates with the text editor and placed within the illustrations of the book where indicated. Thus, in each instance within the book template wherein the subject of the story is pictured, the subject is provided with red hair. Furthermore, in each situation wherein the team's jerseys are illustrated, those jerseys are made green. Thus, depending upon the selections made by the user, the look of the characters within the story may be significantly different.

While there are hundreds of layers possible for any single final image, only a few dozen (guided by the users choices) are used in compiling the final image. Further, each layer contains only one attribute of one character. For example, if the user selected the main character to be male and have blond hair and tan skin, in one image of the book, there may be a layer called “main character, male, blond hair, straight” comprising one layer. Another layer would be “main character, male, skin color tan” comprising another layer. Both of those these layers may be used along with dozens more in compiling the final image, while several hundred other layers are left unused, such as “main character, female, red hair, curly.” That layer exists, but is not used in the final compilation.

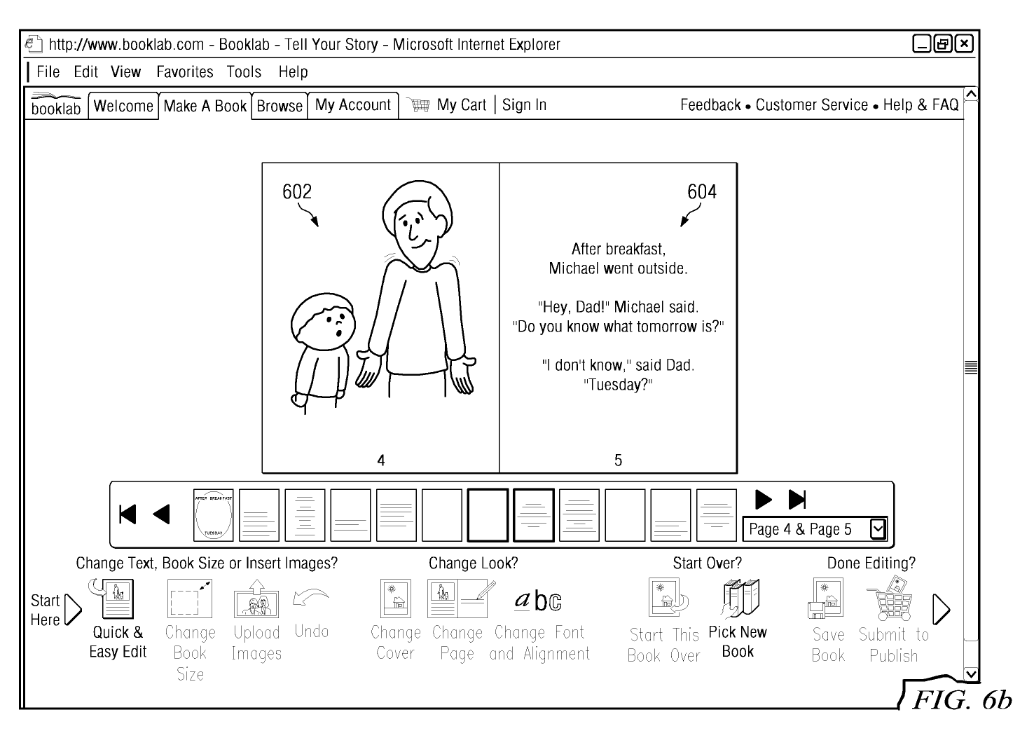

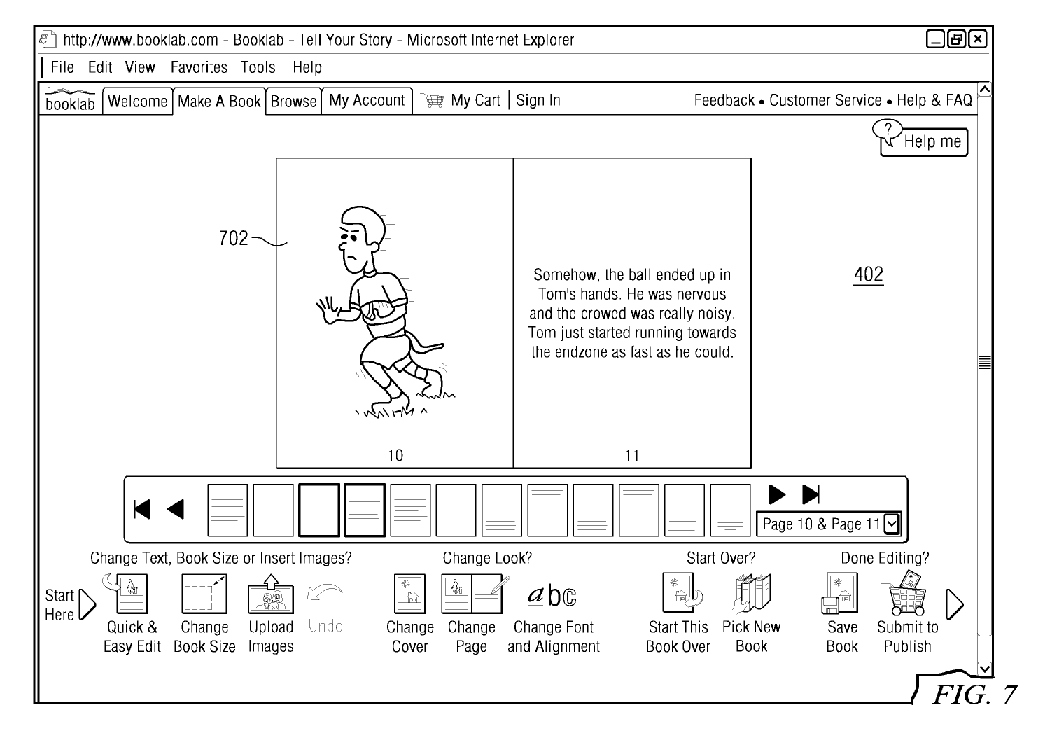

The results of these types of selections of attributes are more fully illustrated in FIGS. 6a and 6b. These figures illustrate pages 4 and 5 of a selected book template when differing selections are made within the personalized book window 502 of the attributes. As can be seen, the illustrations 602 are significantly different depending upon the selections made within the personalized book window 502. Additionally, while the general text associated with the story is similar, various words are altered within the text 604 based upon the user's selections. Thus, the quick and easy edit functionality 302 in association with the dynamic image and text creation process functionality creates similar but different versions of the book from the same template.

Referring now to FIG. 7, there is illustrated a view of the editor page 402 wherein the illustrations within the personalized book window 502 has been selected to make the illustrations of the book in a coloring book format. The illustration 702 in the page viewer is configured as a black and white coloring book style illustration rather then as a colored illustration as illustrated in FIG. 6. This will enable the individual who received the book to use the book as a coloring story book. The coloring book configuration is enabled within the dropdown menu 506c illustrated in the personalized book window 502 of FIG. 5.

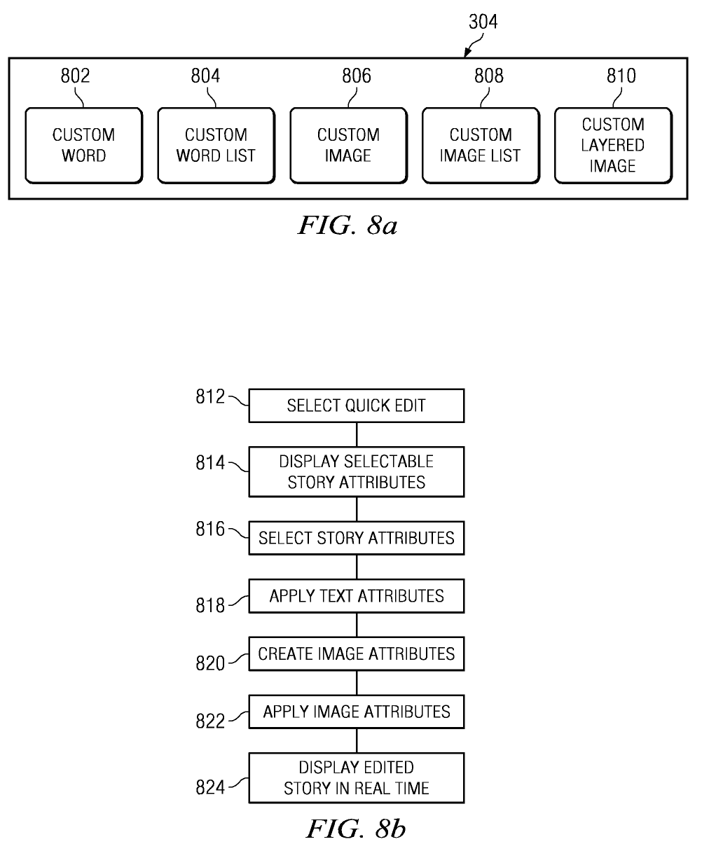

Referring now to FIG. 8a, there is illustrated a block diagram of the various functionalities included within the dynamic image and text creation process functionality 304 which is responsive to the quick edit function 302. The custom word function 802 is used to allow a user to type in a string of text that can be embedded within the story template of the book. This string of text may comprise a single word, a phrase or even a number of sentences. An example of this in the custom word function 802 includes the user typing the word “buzz” into a data entry field and the word “buzz” will then show up at several locations throughout the story. The custom word list function 804 enables a user to select one or more words from a drop down list of possible words to be used within the story. The words may then be inserted into the story or the option can be used to drive the selection of other word or image lists within the dynamic image and text creation process. One example of this would be the customer selects a gender of male from a drop down list and all linked pronouns within the story are altered to his, him, etc. Another example would be that the user selects male, tanned skin tone and blue eyes from the menu. The appropriate image layers are selected such that the illustrated character within the story is shown to be male with tanned skin tone and blue eyes within all illustrations.

The custom image function 806 is used to display a simple image within a page of the book. The customer can upload their own image for direct insertion into the story. The custom image list function 808 is used to display an image that meets particular selection criteria. The selection criteria comprise one or more of the custom word list options that were selected by the custom word list function 804. An example of this would be that the custom image list would be linked to the custom word list and not be alterable by the user. The selection specific physical characteristics within the custom word list would yield specific image results that would be displayed within the pages of the book. An example of this would be the customer selecting male, tanned skin tone and blue eyes. The appropriate image layers would be created such that the character when illustrated within the story would have these characteristics. The custom layered image function 810 is used to display an image that is composed of one or more images layered on top of each other. Each layered image must meet selection criteria to be included. The selection criteria are one or more of the custom word list function options selected previously. The custom layered image function list would be also linked to the custom word list function 804. Customer word list selections may require several images to compose a final image including character attributes, background, etc. Thus, customer selecting none of the attributes, but a favorite toy (bicycle) and a background (outdoor) will require the selection of the bicycle and background layer in addition to any other image list selections.

FIG. 8b provides a flow diagram more fully illustrates the process for dynamic image and text creation according to the system of the present invention. Initially, selection of the quick edit mode at step 812 initiates the dynamic text and image creation functionalities. Responsive to selection of the quick edit mode the window displaying the various selectable story attributes is displayed at step 814. Using the various data entry fields and drop down menus within the selectable story attribute window, the user selects the story attributes to personalize the story in a manner they desire at step 816. Once the desired story attributes had been selected, the text editor dynamically applies these attributes at step 818 that have been selected by the user. Application of the text attributes involved going through the story template and in each instance in the case of a “one-to-one” relationship or each related instance in the case of a “one-to-many” relationship were a particular text attribute has been selected applying that attribute.

Next, at step 820 the image attributes associated with the various illustrations are created. This may involve creating an image in a layered level if multiple image layers are to be associated together. For example if the character was designated as having curly hair and is also designated as having blond hair the image layer is necessary to illustrate a character of having both curly and blonde hair must be created. Additional illustration and image attributes are created as necessary according to the user selected attributes. Once these have all been created at step 820 the generated images are applied to the story at step 822 to create the final illustrations according to the user selected attributes. The story is displayed in real time at step 824 to include the user designated text and image attributes that have been established.

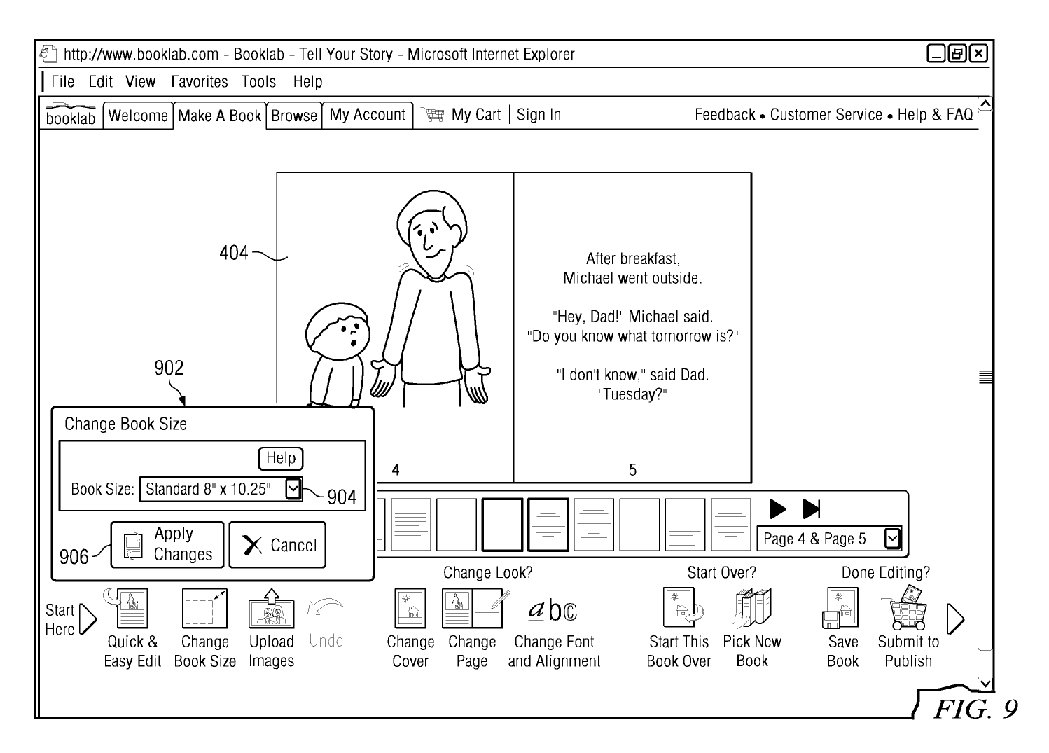

The change book size icon 426 and the remaining icons of the editor menu 414 are available for access once the quick and easy edit process has been carried out by the user. The change book size icon 426 causes display of the change book size window 902 as illustrated in FIG. 9. The change book size window 902 includes a drop down window 904 enabling the user to select a particular book size. These sizes may be of any offering such as board book, travel book, comic book, standard book size, and scrap book. Standard book size comprises 8 inches by 10.25 inches, standard travel size comprises 6.5 inches by 8.5 inches, comic book size comprises 6.5 inches by 10.25 inches and scrap book landscape comprises 11 inches by 9 inches. Once the desired book size has been selected, the apply changes buttons 906 may be selected to apply the selected book size changes and the page viewer window 404 will change its size to the selected book size view.

Certain combinations of templates and book sizes are not allowable based upon the physical structure of the book or the required number of pages. For example, children's board books are not capable of having more than 14 pages due to the pages inherent thickness. On the other hand, while changing a template whose devolved size is a board book and limited to 14 pages to a larger sized book with a greater number of page maximum is allowed, the book may end up having blank pages at the end. Of course using the functionalities which will be more fully described herein below, the user would have the option to remove these pages prior to publishing.

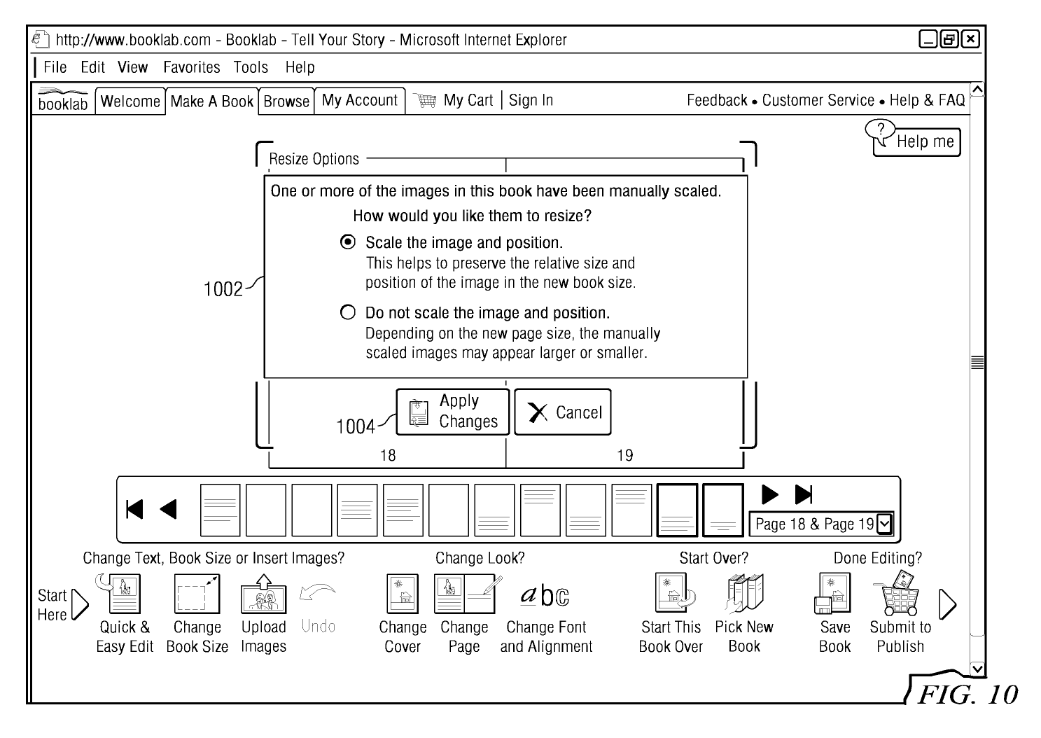

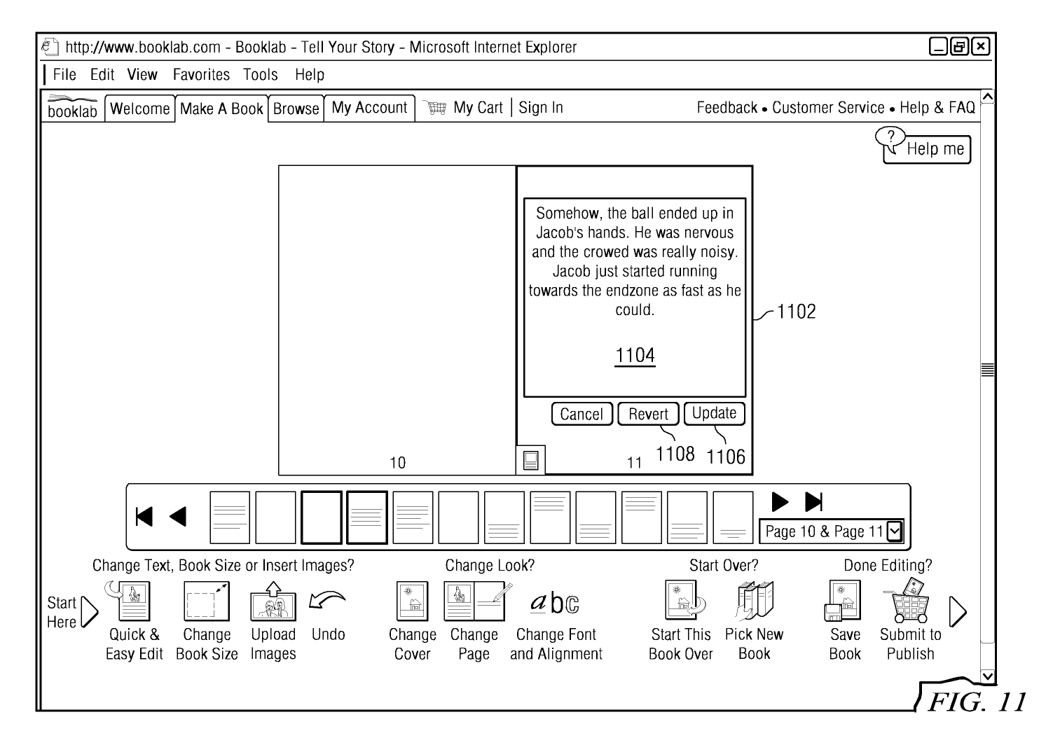

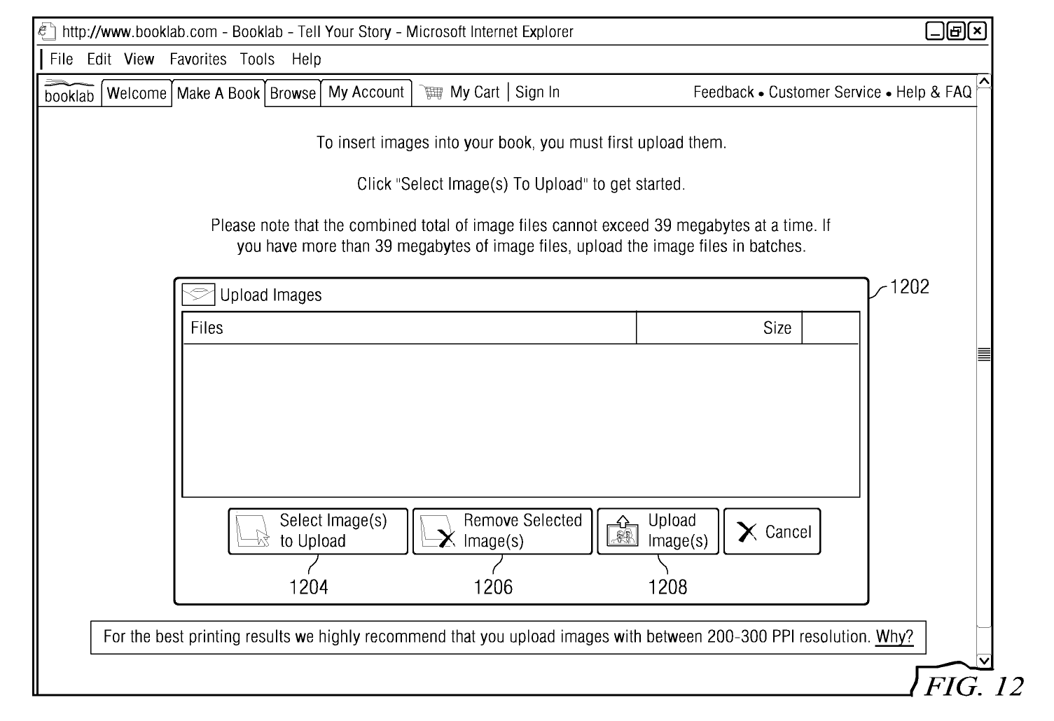

When the book size is changed, images can be scaled to fit or left as they are. When this occurs, as illustrated in FIG. 10, the resize options window 202 will appear. The resize option box 1002 provides the option to scale the images and position within the book to maintain relative size and position within the new book size. Alternatively, the user may select to not scale the image and position and these may be manually entered by the user. The selection is applied by selecting on the apply changes button 1004.

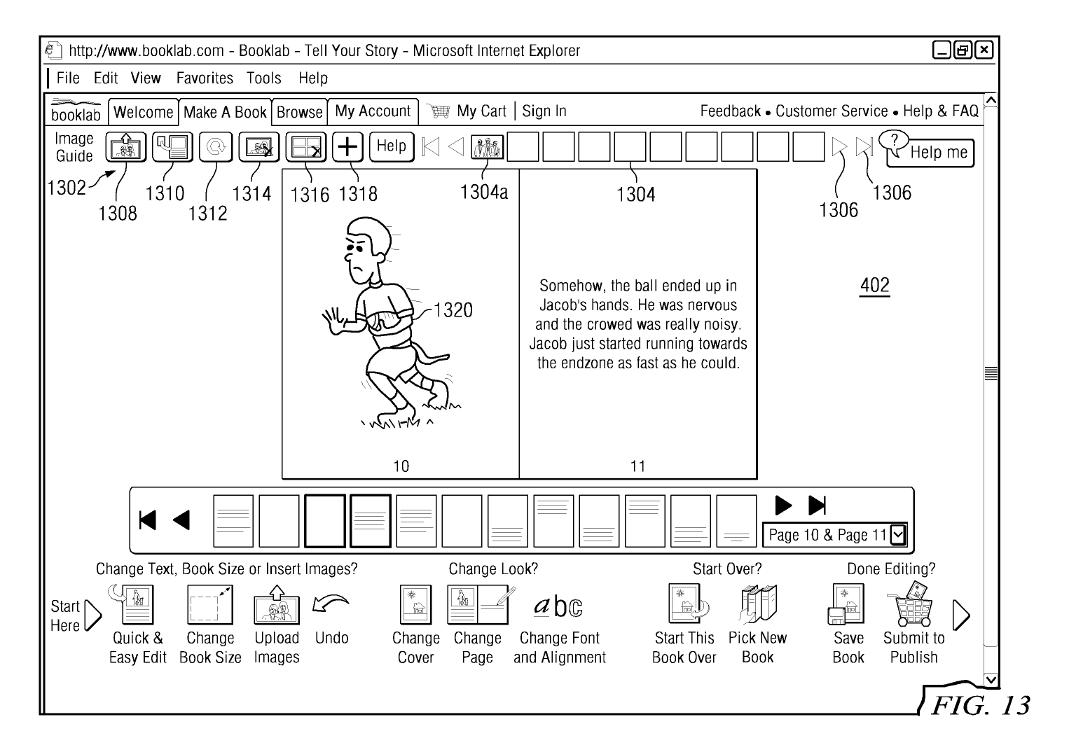

The text edit function 316 (FIG. 3) is accessed by clicking on any text within the book template. When the text is clicked on, the text portion appears in a highlighted text window 1102 as illustrated in FIG. 11. The text window 1102 places the text of the book within a window that may be edited by the user in any manner desired within the text field 1104. When the desired text entry has been completed, the text within the window may be updated and made a part of the book template by clicking on the update button 1106. Using this technique nearly any text within the book may be edited. Certain text in sections may be locked in order to prevent the work for being altered. The text field 1104 may be highlighted in some type of different color in order to provide a visual indication to the user that the text is now editable. The text is displayed without a specific font or any vertical alignment. The text is shown at the top of the text field 1104 in Arial format. The text is also saved within the text field 1104 when the user leaves the box even if they do not click upon the update button 1106. If the user desires to return to the original text, they may do so by clicking on the revert button 1108.

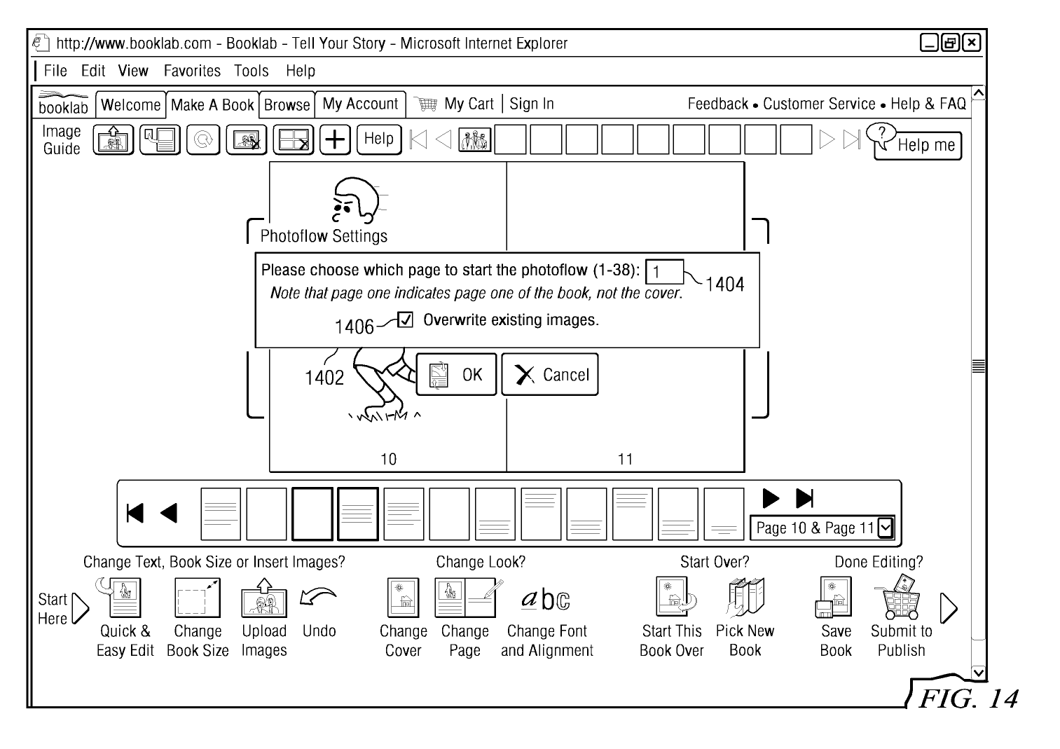

By clicking on the upload image icon 428, the add image function 310 is accessed and provides access to the upload image window 1202, as shown in FIG. 12. By clicking on the select images to upload button 1204, the user has the ability to browse through their computer. This is being used to access the server in order to select the images they desire to upload. Various images that are not desired can be removed via the remove selected images button 1206. Once all the desired images have been selected, the upload images button 1208 may be clicked to enable uploading of the desired pictures from the computer to the online editor server. The add image functionality 310 can accept any image format (jpg, gif, png, etc.) The preferred embodiment requires a minimum image resolution of 200 dpi for full page illustrations. For smaller images areas, less resolution is required and thumbnail images are typically fine.

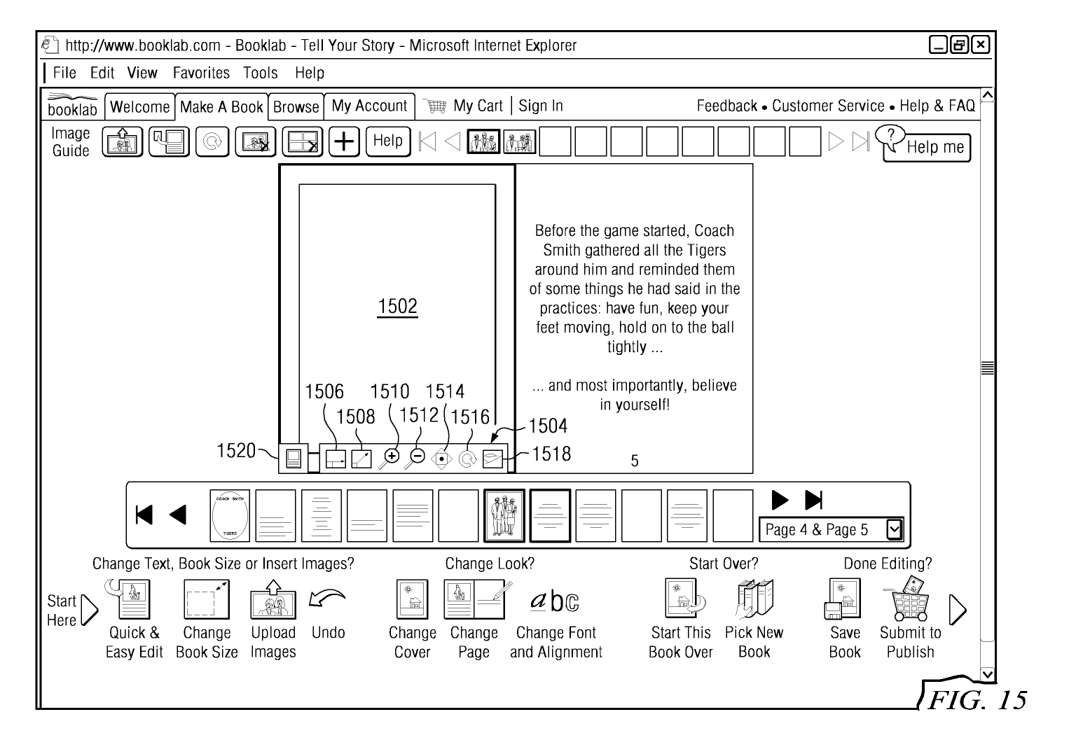

Referring now to FIG. 13, once at least one image has been uploaded into the editor the main editor screen 402 will include an image guide 1302. The image guide 1302 includes a number of functionalities enabling the images that have been uploaded via the add image function 1302 to be manipulated. The image guide 1302 is part of the graphical user interface provided by the manipulate images functionality 1312. The image guide 1302 includes a number of thumbnail windows 1304 for storing each picture that has been downloaded by the user. The user may maneuver through the downloaded images by highlighting each of the thumbnail windows 1304 using the control arrows 1306 or a conventional mouse pointer. The control arrows 1306 enable the user to move one image at a time forward or backwards or all the way to the beginning and the end of the available images. The add more images button 1308 enables the user to add additional images to the thumbnail windows 1304. The photo flow button 1310 enables a user to sequentially insert photos from the sequence of thumbnail windows 1304 into sequentially occurring image fields within the book template. This will be more fully discussed herein below. The rotation button 1312 enables the user to rotate a highlighted image as desired. The delete button 1314 or delete all button 1316 allows a user to delete either individual highlighted images or all of the pictures within the thumbnail windows 1304. The expand button 1318 allows an individual to expand or collapse the image guide 1302.

The images stored within the thumbnail windows 1304 may have their sequence changed or be stored within a particular image location within the book template by using a drag and drop procedure utilizing the mouse in the graphical interface. Thus, the image 1304a could be dragged and dropped in place for the illustration 1320 within the page view of the editor 402. Additionally, the image to be placed in a separate location within the sequence thumbnail windows 1304 using a drag and drop procedure. Additionally, all images in the image guide 1302 can be inserted sequentially into the book using the photo flow button 1310. By clicking on the photo flow button 1310, the photo flow function associated with the manipulate images functionality 1312 automatically inserts all images from the image guide 1302 directly into the book template. The images are inserted into the book template in the same order that they are within the image guide 1302 from left to right. The order of the images may be altered within the image guide 1302 prior to using the photo flow functionality using a drag and drop technique. When user selects the photo flow button 1310, the photo flow settings window 1402 will appear as shown in FIG. 14. The user will enter within data field 1404 the page to began inserting the images into the book template and indicate within the check mark field 1406 whether they should overwrite existing images.

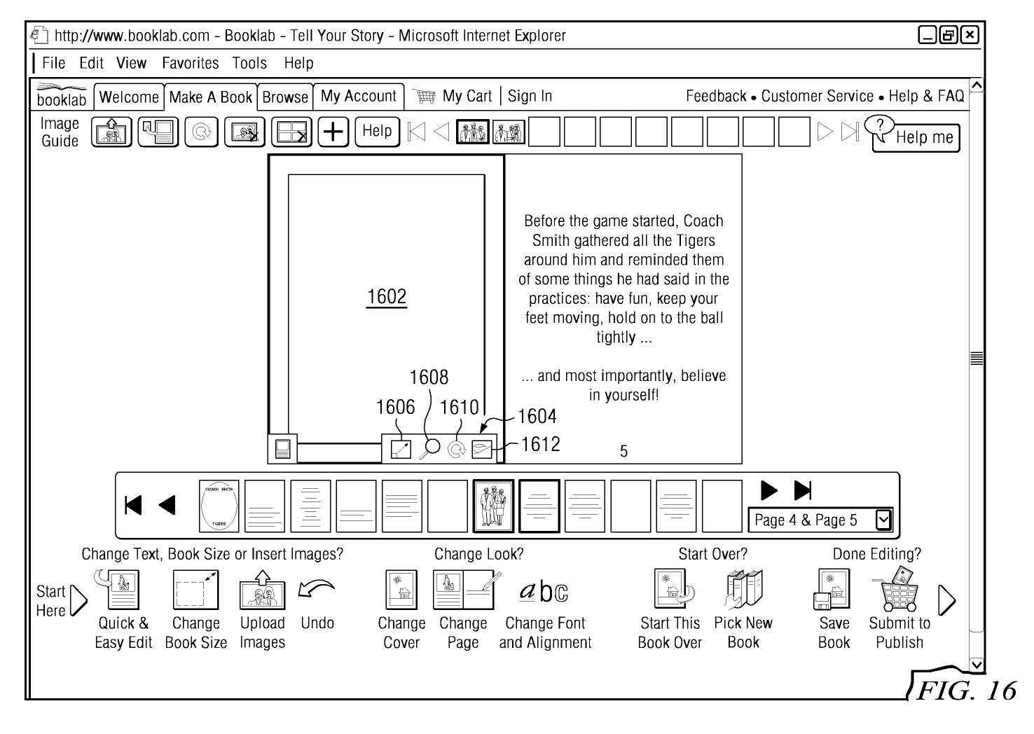

Referring now to FIG. 15, once an image has been inserted into the book template the user may click on the image to pull up the edit image window 1502. The edit image window 1502 includes an image tool bar 1504 enabling the user to edit the image in a number of fashions. A scale image button 1506 enables the user to scale the size of the image within the book template without preserving the aspect ratio of the picture. The scale image button 1508 enables the user to scale the size of the image while preserving the aspect ratio of the image. The manipulate image function will fit an image into the available area so that the empty space of the available page area is filled while maintaining the aspect ratio of the image. Thus, there is no stretching or skewing of the image it is only scaled up until all of the image area space is filled.

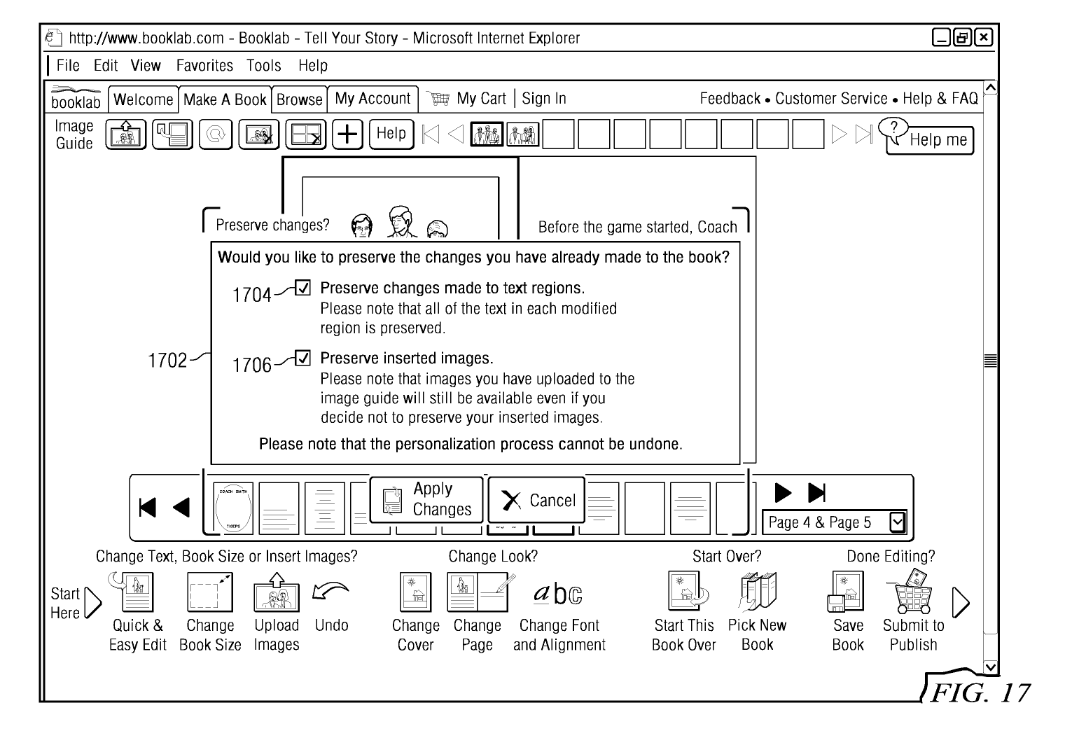

Referring now also to FIG. 16, when an image in the viewing window is clicked on, the resealed image 1602 will appear. The image menu 1604 within the resealed image 1602 will include a button 1606 enabling the image to be resealed to fit the available space, an icon 1608 enabling the image to be scaled manually and a rotation icon 1610 to enable the positioning of the icon to be rotated at 90 degrees increments. The image may also be reverted back to its original position with icon 1612. The main image menu 1604 also includes an icon 1510 for expanding the image, an icon 1512 for zooming out from the image, an icon 1514 enabling positioning or moving of the image and a icon 1516 enabling rotation of the image. The image may be reverted back to its original state using either icon 1518 or icon 1520.

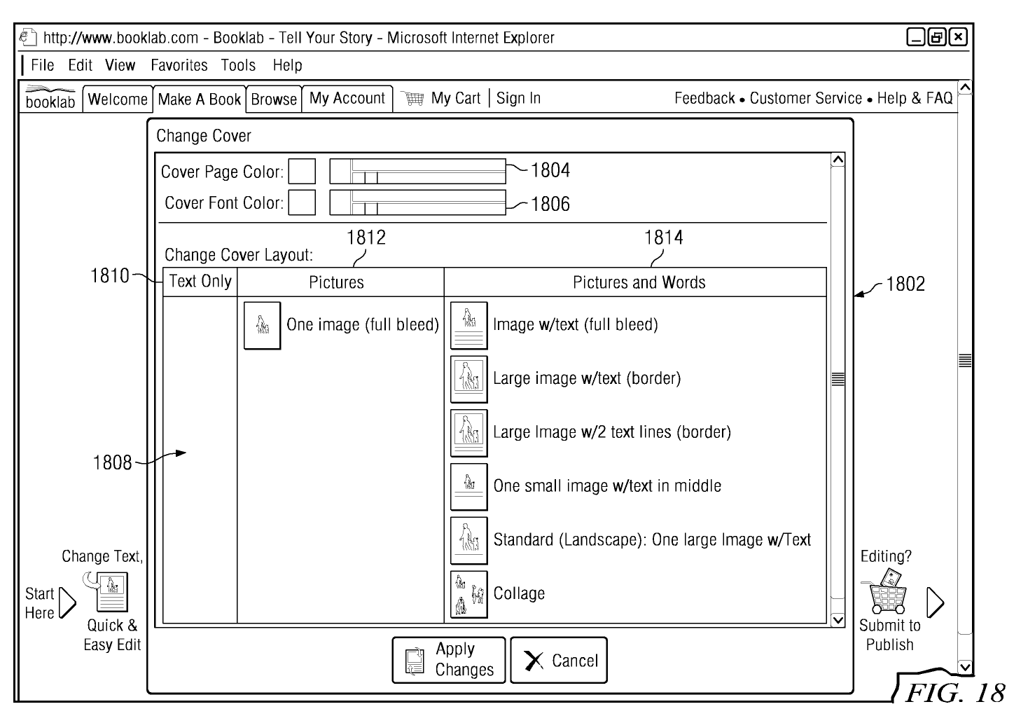

Once all of the specific edits to text and images have been made using the above-described system and method, the user may return to the quick and easy functionality 1302 to perform additional basic edits. However, if the basic edits are revised, an alert such as that illustrated in FIG. 17 will appear. This alert 1702 gives the user the option to confirm changes that have previously been made within the book template whether they be text 1704 or images 1706. The reason for this is that once a user starts editing text or images within the book template, any text or image that is changed by the quick and easy edit function 302 may be changed. If the user alters any of the global text or images through the advanced editing, the quick and easy edits would no longer be global. So returning to the quick and easy edit mode to reenter data would be useless as some of these advanced mode text edits were retained.

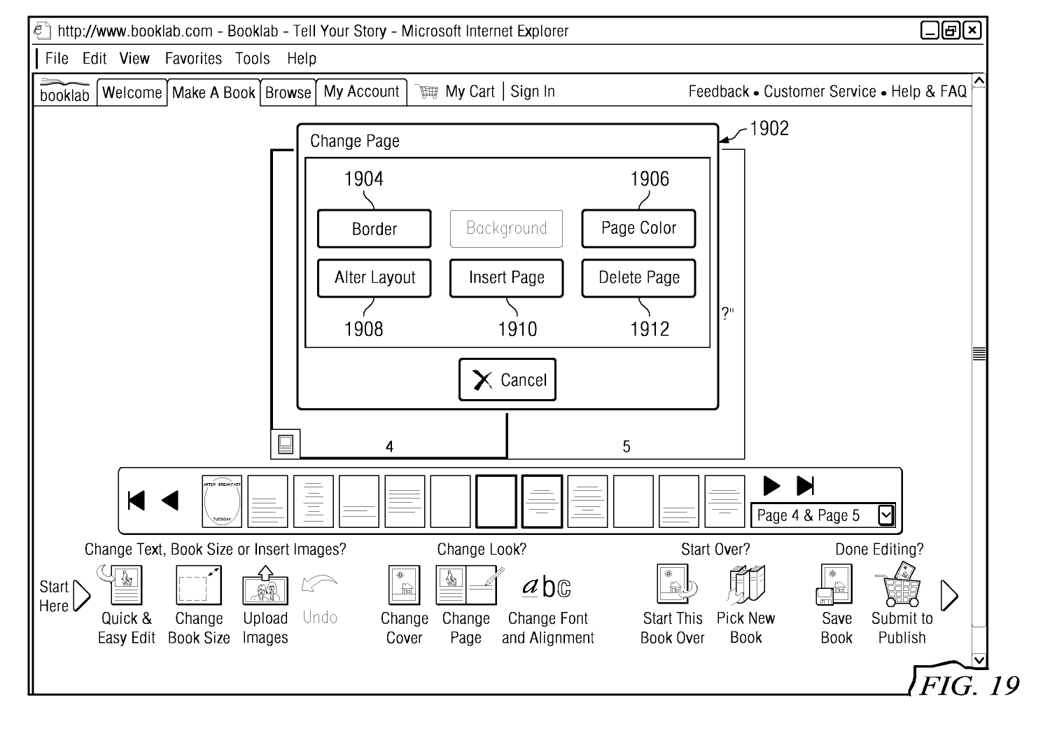

The change look section 418 enables a user to change the cover of the book using icon 432, change a page look using icon 434 or change the font of the text within the book using icon 436. To change the background colors and layout of the cover of the book the change cover icon 432 is selected to give you access to change cover and pages function 316. Clicking on the change cover icon 432 provides the change cover window 1802 as illustrated in FIG. 18. The change cover window 1802 provides the user with a cover page color bar 1804 and a cover page font color 1806. The cover page color bar 1804 enables the user to select the colors associates with the cover pages and the cover page font color bar 1806 enables the user to select the colors associate with the font of text on the cover page. The cover layout selections 1808 enable the user to select a variety of configurations for the layout of the cover. A text only layout 1810 enables the user to select a text only cover and enter this option in the text only column. The pictures only column 1812 allows the users to select a single image picture cover option. The pictures and words section 1814 enables the user to select among a number of options of combined text and images within the book cover layout. These include images with text, large images with text large images with two text lines, one small image with text in the middle, standard landscape configuration and a collage. Other options are of course available and may be programmed into the editor as desired.

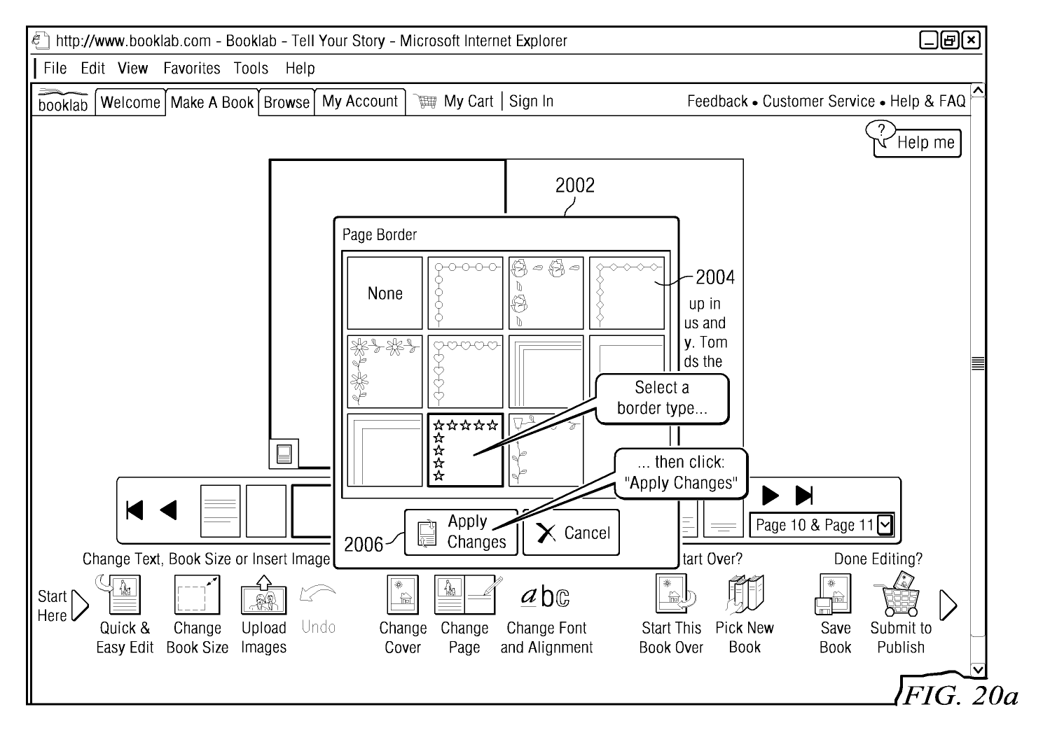

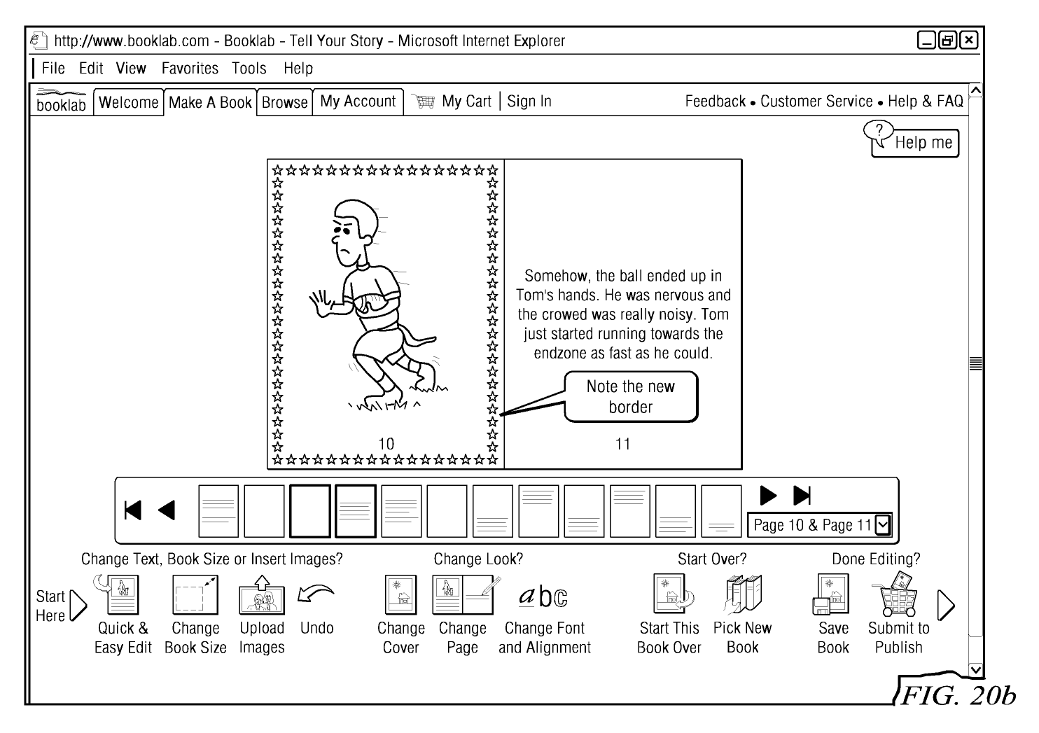

Referring now to FIG. 19, there is illustrated the change page window 1902 that appears upon activation of the change page icon 434 associated with the change cover and pages functionality 316. Before clicking on the change page icon 434 the user must select a particular page within the page view window 404. The change page dialog box includes a number of buttons enabling revisions to these features within the page. The border button 1904 causes opening of the page border window 2002 as illustrated in FIG. 20a. The page border widow 2002 includes a variety of selections 2004 that may be used as borders for the selected page. Once the desired border is selected the changes may be applied by selecting the apply changes button 2006. Once the apply changes button 2006 is selected the border will then appear around the selected page as illustrated in FIG. 20b.

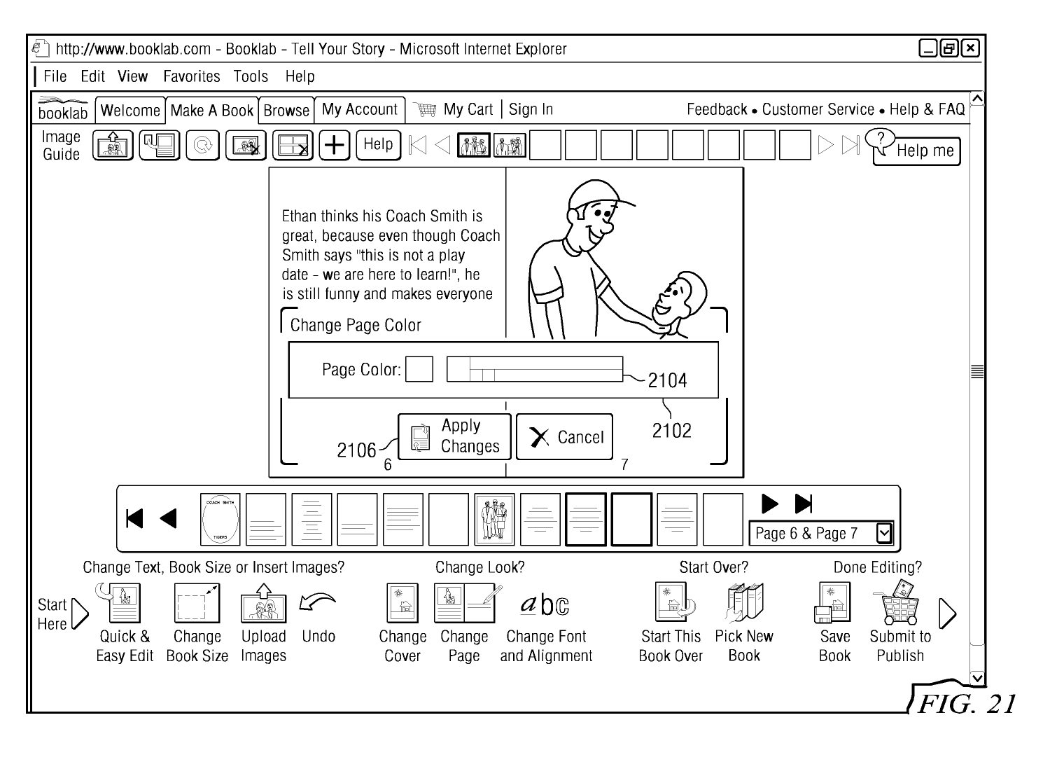

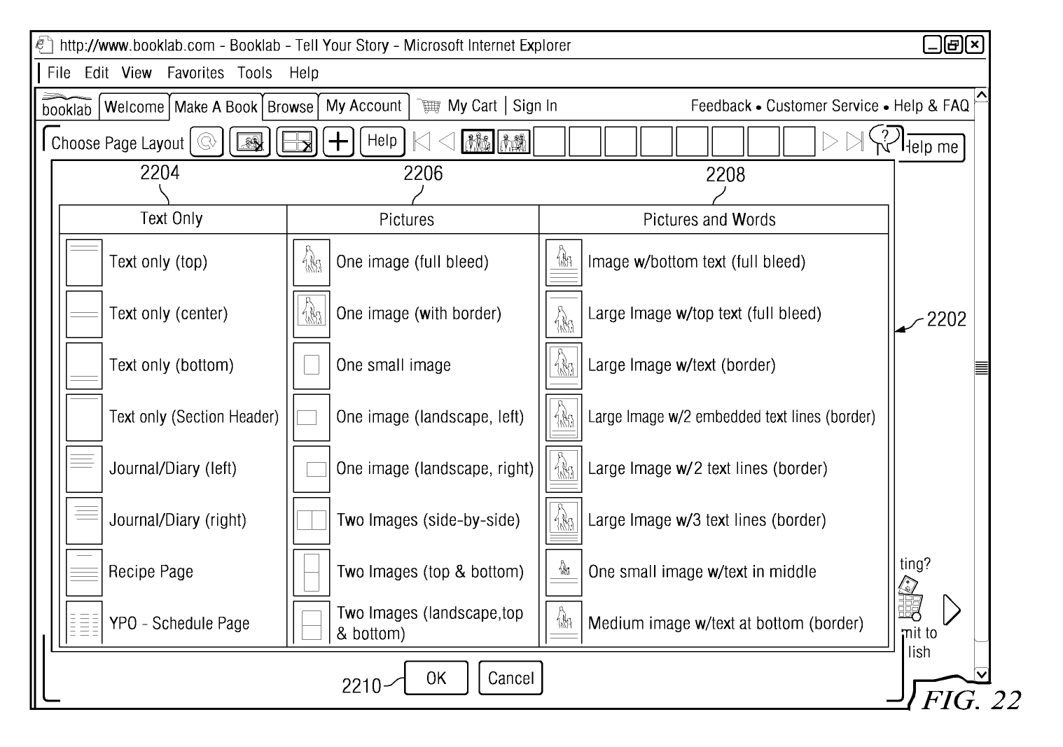

Referring now back to FIG. 19, by clicking on the page color button 1906 the user will cause a page color bar window 2102 to appear as shown in FIG. 21. The page color bar window 2102 includes a color bar 2104 enabling the user to select a particular color for the selected page. The page color change may then be applied by selecting the apply changes button 2106.

Referring now back again to FIG. 19 by clicking on the alter layout button 1908, the choose page layout window 2202 will be displayed. The chose page layout window has a text only section 2204, a pictures section 2206 and a pictures and words section 2208. The text only section 2204 provides a number of options for arranging the text within a book page. The pictures options 2206 provide a number of options for organizing the pictures upon a book page. Finally the pictures and words options 2208 provide a number of options for arranging a combination of pictures and words on the same page. The selected page layout format is confirmed by selecting the OK button 2210.

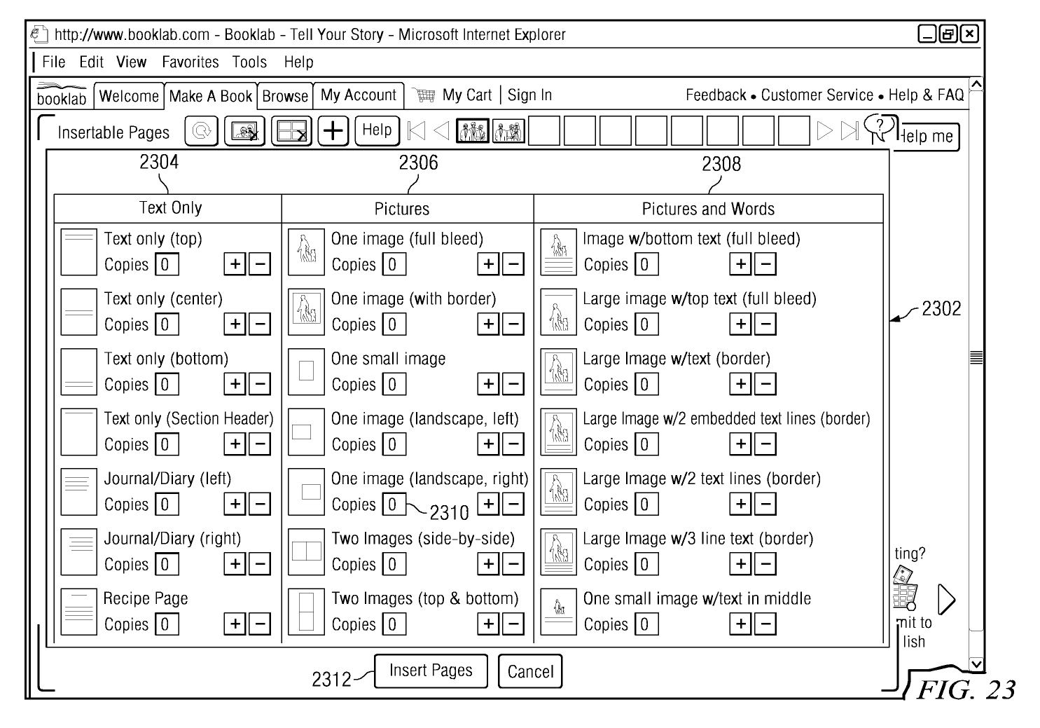

The insert page button 1019 of FIG. 19 causes the display of the insertable pages window 2302 as illustrated in FIG. 23. The insertable pages window 2302 also includes the text only column 2304, pictures column 2306 and pictures and words column 2308 as described previously with respect to FIG. 22. Each of these sections includes various text, picture and combination of picture and text options for format of the inserted pages. Additionally, each option includes a data field 2310 enabling the user to select the number of pages to be inserted having the particular selected format. The location of the insert may also be set. The pages are inserted by clicking on the insert page button 2312.

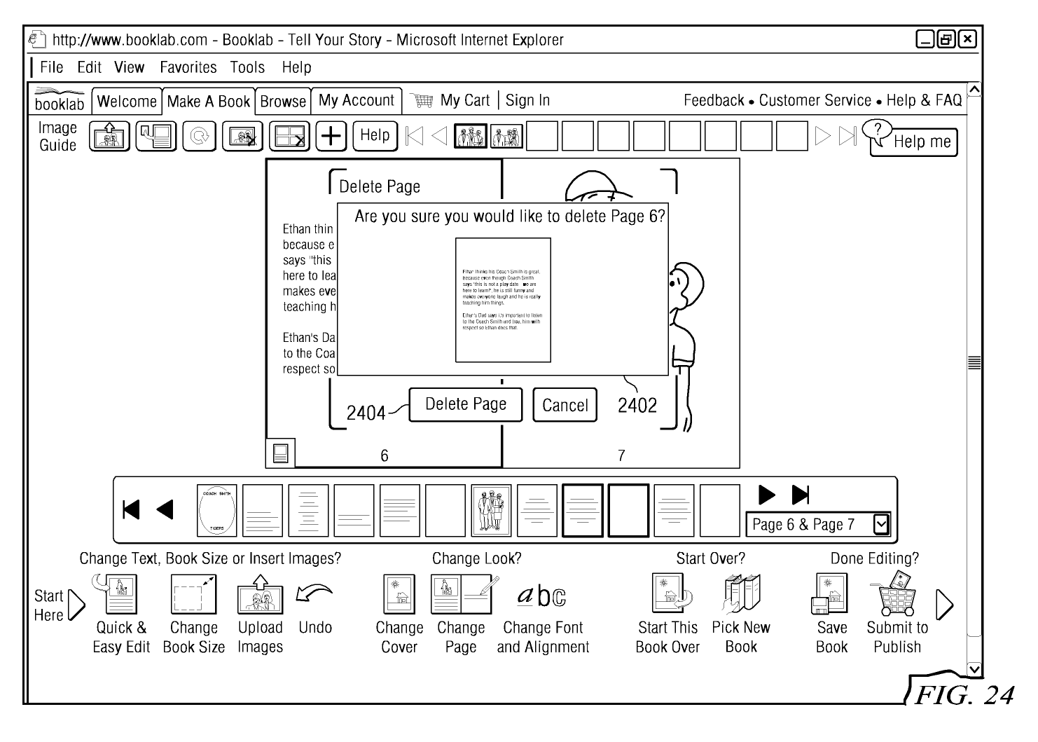

In order to delete a page, the page to be deleted is initially selected within the page view window 1404. The user will then select on the change page button 434 (FIG. 4) to bring up the change page window 1902 and click on the delete page button 1912. Responsive to this a delete page window 2402 appears as illustrated in FIG. 24 asking the user if they are sure they wish to delete the selected page. If so, the user selects the delete page button 2404 to confirm the deletion and cause the page to be deleted from the template.

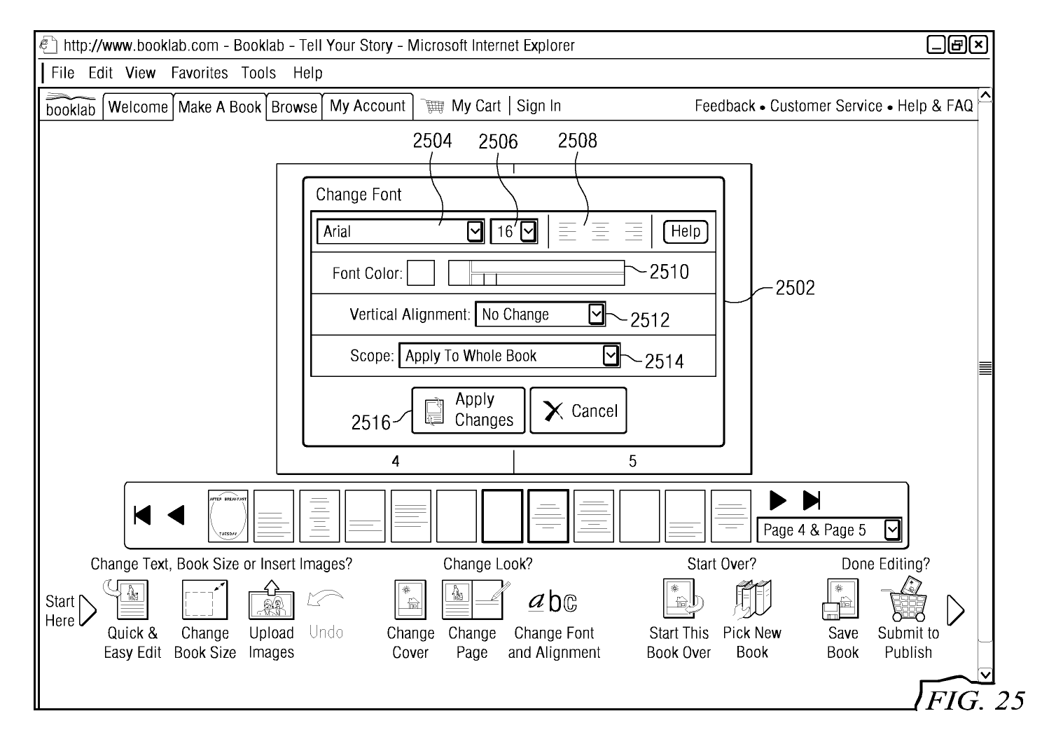

The user may also change the font and alignment of text within the book template by clicking on the change font and alignment icon 436 (FIG. 4) providing access to the text edit font and alignment functionality 316. Initially, the user selects the text that is to be changed. Responsive to this, the change font window 2502 appears as illustrated in FIG. 25. The change font window 2502 includes a font data field 2504 for selecting the font type to be used and a font size field 2506 for selecting font size. Justification menu 2508 enables the user to select whether the text is right, left or center justified. The font color bar 2510 enables the user to select the color of the text. The vertical alignment data field 2512 allows the user to establish the vertical alignment of the text. The text can be vertically aligned at the top, center or bottom. Additionally, the scope data field 2514 can allow the indicated changes to be applied only to the selected text or to the entire book. The indicated changes are applied via the apply changes button 2516.

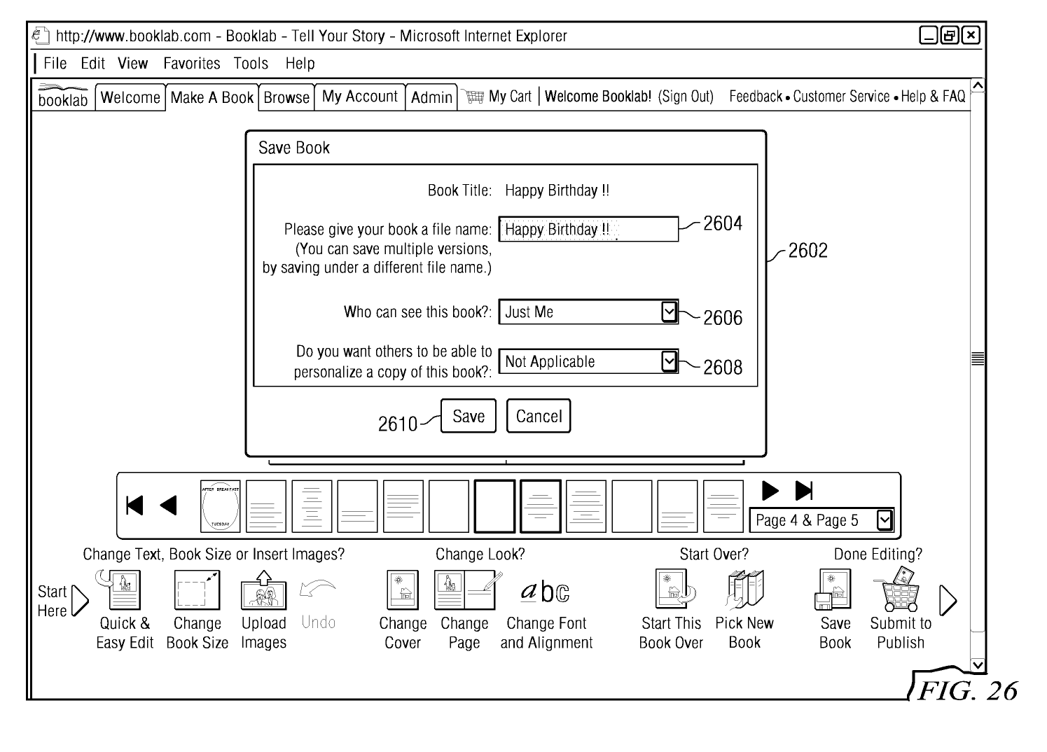

These comprise all of the editing functionalities that are associated with the editor page 402. Once a book template has been created and edited as desired through the editor page 402, the user may save the book for later editing or for publication. To save the book whether or not it is completed, the user clicks on the save book icon 442 within the done editing section 422 in order to access the save book function 320. Clicking on the save book function 442 displays the save book window 2602 of FIG. 26. The save book window 2602 includes a name field 2604 enabling the user to provide a file name for the book. The access rights menu 2606 allows the user to establish who will have the ability to view this file. Finally, the editing field 2608 establishes the individuals who will have the ability to further personalize a copy of this book for their own use. This information may be saved by clicking on the save button 2610. Before being able to save a book in this fashion a user may be required to log into an associated system using a user name and password as is well known in the art.

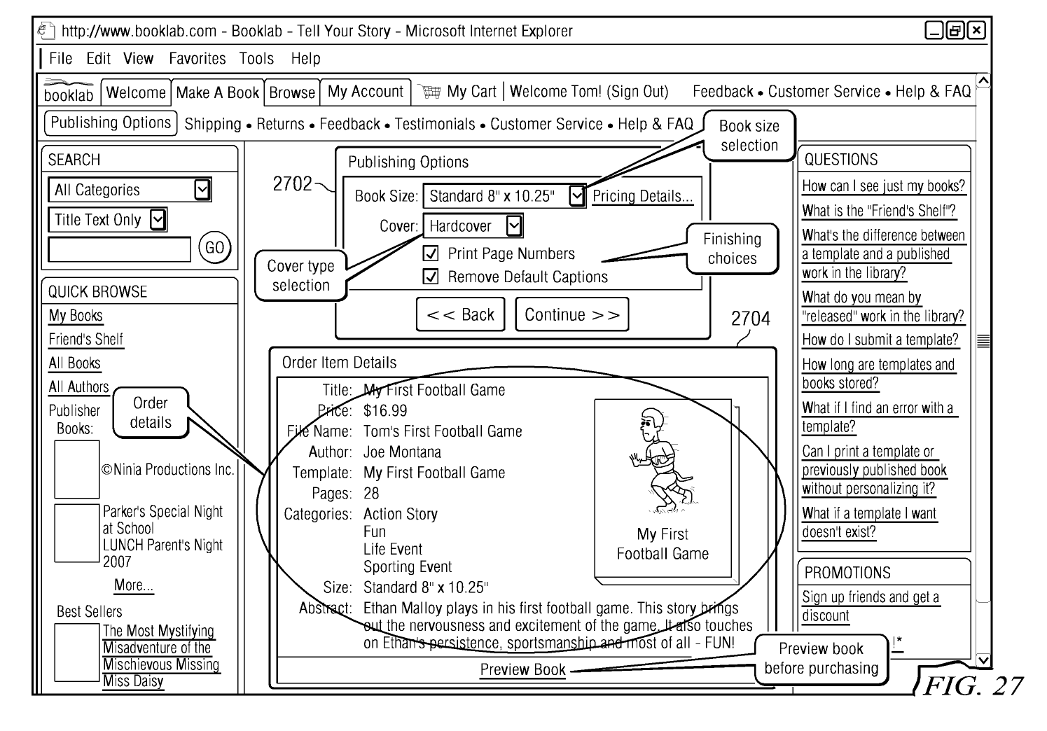

Referring now to FIG. 27, once the book has been saved, the user may publish the book by clicking on the submit to publish icon 444. Clicking this button will display the publishing options window 2702 and the order item details window 2704. The publishing options window contains selections such as book size and whether the book cover is a hard cover or soft cover. The order details section provides the title, price, file name, author, template, page numbers and type of story that is included. Once the publishing options are selected the user may then check out and purchase a book in a known manner.

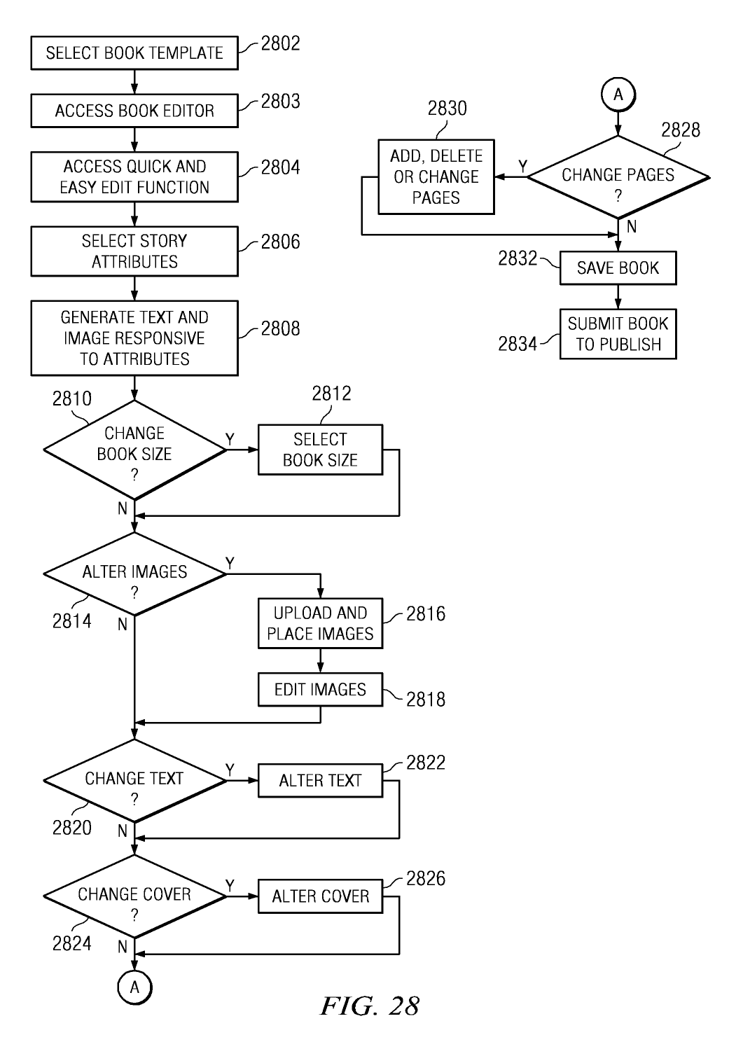

Referring now to FIG. 28, there is illustrated a flow diagram describing the general operation of the editor described herein above. Initially at step 2802, the user selects a particular book template for use with the personalized book that they intend to create. At step 2803, the user accesses the book editor. Upon accessing the book editor, the user must initially activate at step 2804 the quick and easy edit functionality. Once the quick and easy edit functionality has been accessed, the user will select a variety of previously established story attributes that are defined within the selected story template at step 2806. Once all the necessary story attributes have been selected, the editor revises in real time, the text for the story and images for display in the story responsive to these selected attributes at step 2808. This provides the basic story configuration which may be specifically personalized and edited by the user. Inquiry step 2810 determines whether the user desires to alter the book size initially established for the book. If so, the desired book size is selected at 2812 by the user. Once the desired book size is selected or if no change in the book size is desired at step 2810, inquiry step 2814 decides whether the user desires to alter particular illustrations and images within the existing book. If so, control passes to step 2816 wherein the user may upload various images into the book editor and place these images in desired locations within the book at step 2816. The user next has the ability to edit at step 2818, the various images that have been added into the story in a desired manner.

Once all of the desired images have been created or if no changes to the existing illustrations are desired, inquiry step 2820 determines whether the user desires to change any text within the story. If so, the user is able to alter any desired text within the book at step 2822 and these changes are saved. After any desired text has been altered, inquiry step 2824 determines whether the user desires to alter the cover of their book. If so, the user is able to select various attributes associated with the cover and alter it at step 2826. Next, at inquiry step 2828, a determination is made if the user desires to change any pages of their story. If so, the user may add pages, delete pages or make various format changes to the pages of the book at step 2830. Once this has been completed or if no changes are made to the book, the user has the opportunity to save the book that they have been creating and personalizing at step 2832. Once their book has been saved, it may be submitted for publication at step 2834.

Using the above described book editor, a user may create a personalized book online using a selected story template, quickly editable story attributes and have the flexibility to alter almost any attribute or illustration within the story. This will enable the user to provide a uniquely personalized book creation experience. In addition to implementing the system within an online system through for example the internet, the book editor could be implemented completely locally to a software application installed on a personal computer of a user.

It will be appreciated by those skilled in the art having the benefit of this disclosure that this dynamic image and text creation for online book creation system provides a manner for quickly creating and displaying text and image changes in real time. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for dynamically editing a publication, comprising the steps of:
selecting a publication template from a plurality of publication templates, said publication template including a plurality of publication attributes;
displaying the publication in a graphical user interface responsive to the selected publication template;
displaying via the graphical user interface a selected group of the plurality of publication attributes;
receiving inputs defining particular entries for the selected group of the plurality of publication attributes through the displayed selected group of the plurality of attributes;
applying the particular entries to each occurrence of the associated publication attributes within the publication template; and
updating the display of the publication to reflect the particular entries in the publication in the graphical user interface in real time.

2. The method of claim 1, the step of displaying the selected group of the plurality of publication attributes further comprises the steps of:
displaying at least one text attribute; and
displaying at least one illustration attribute.

3. The method of claim 1, wherein the step of applying further comprises the steps of:
locating each occurrence of the publication attributes in the publication template for which the particular entry has been received; and
changing each located occurrence of the publication attributes to an entry associated with the received particular entry.

4. The method of claim 3, wherein the step of locating comprises the step of locating text attributes in the publication for which the particular entry has been received.

5. The method of claim 3, wherein the step of changing comprises the step of changing each located occurrence of the publication attributes to the received particular entry.

6. The method of claim 3, wherein the step of locating comprises the step of changing each located occurrence of the publication attributes to an entry related to the received particular text entry.

7. The method of claim 3, wherein the step of locating comprises the step of locating illustration attributes in the publication for which the particular entry has been received.

8. The method of claim 3, wherein the step of changing further comprises the steps of:
changing a first illustration attribute in the publication for which the particular entry has been received;
changing at least one second illustration attribute in the publication for which the particular entry has been received; and
overlaying the first illustration attribute with the at least one second illustration attribute to create a combine illustration attribute that changes an illustration in the publication template to reflect both the first and the at least one second illustration attributes.

9. The method of claim 1, wherein the step of displaying the selected group of the plurality of publication attributes further comprises the steps of:
displaying a freeform data field for each of a first group of the selected group of the plurality of publication attributes, wherein any user defined entry may be placed in the data field; and
displaying a drop down menu for each of a second group of the selected group of the plurality of publication attributes, wherein the dropped down menu contains a plurality of predefined entries for selection.

10. A method for dynamically editing a publication, comprising the steps of:
selecting a publication template from a plurality of publication templates, said publication template including a plurality of publication attributes;
displaying the publication in a graphical user interface responsive to the selected publication template;
displaying via the graphical user interface a data field for each of a first group of a selected group of the plurality of publication attributes, wherein any user defined entry may be placed in the data field; and
displaying a drop down menu for each of a second group of the selected group of the plurality of publication attributes, wherein the dropped down menu contains a plurality of predefined entries for selection;
receiving inputs defining particular entries for the selected group of the plurality of publication attributes through the displayed selected group of the plurality of attributes;
locating each occurrence of the publication attributes in the publication template for which the particular entry has been received;
changing each located occurrence of the publication attributes to an entry associated with the received particular entry; and
updating the display of the publication to reflect the particular entries in the graphical user interface in real time.

11. The method of claim 10, the step of displaying the selected group of the plurality of publication attributes further comprises the steps of:
displaying at least one text attribute; and
displaying at least one illustration attribute.

12. The method of claim 10, wherein the step of locating comprises the step of locating text attributes in the publication for which the particular entry has been received.

13. The method of claim 10, wherein the step of changing comprises the step of changing each located occurrence of the publication attributes to the received particular entry.

14. The method of claim 10, wherein the step of locating comprises the step of changing each located occurrence of the publication attributes to an entry related to the received particular text entry.

15. The method of claim 10, wherein the step of locating comprises the step of locating illustration attributes in the publication for which the particular entry has been received.

16. The method of claim 10, wherein the step of changing further comprises the steps of:
changing a first illustration attribute in the publication for which the particular entry has been received;
changing at least one second illustration attribute in the publication for which the particular entry has been received; and
overlaying the first illustration attribute with the at least one second illustration attribute to create a combine illustration attribute that changes an illustration in the publication template to reflect both the first and at least one second illustration attributes.

17. A system for dynamically updating a publication, comprising:
a graphical user interface for displaying an image of the publication responsive to a publication template, wherein the graphical user interface is configured to:
receive a selection of the publication template from a plurality of publication templates, said publication template including a plurality of publication attributes;
display the publication in a graphical user interface responsive to the selected publication template;
display via the graphical user interface a selected group of the plurality of publication attributes;
receive inputs defining particular entries for the selected group of the plurality of publication attributes through the displayed selected group of the plurality of attributes;
apply the particular entries to each occurrence of the associated publication attributes within the publication template; and
update the display of the publication to reflect the particular entries in the publication in the graphical user interface in real time.

18. The system of claim 17, wherein the graphical user interface is further configured to:
display at least one text attribute; and
display at least one illustration attribute.

19. The system of claim 17, wherein the graphical user interface is further configured to:
locate each occurrence of the publication attributes in the publication template for which the particular entry has been received; and
change each located occurrence of the publication attributes to an entry associated with the received particular entry.

20. The system of claim 17, wherein the graphical user interface is further configured to locate text attributes in the publication for which the particular entry has been received.

21. The system of claim 17, wherein the graphical user interface is further configured to change each located occurrence of the publication attributes to the received particular entry.

22. The system of claim 17, wherein the graphical user interface is further configured to change each located occurrence of the publication attributes to an entry related to the received particular text entry.

23. The system of claim 17, wherein the graphical user interface is further configured to locate illustration attributes in the publication for which the particular entry has been received.

24. The system of claim 17, wherein the graphical user interface is further configured to:
change a first illustration attribute in the publication for which the particular entry has been received;
change at least one second illustration attribute in the publication for which the particular entry has been received; and
overlay the first illustration attribute with the at least one second illustration attribute to create a combine illustration attribute that changes an illustration in the publication template to reflect both the first and at least one second illustration attributes.

25. The system of claim 17, wherein the graphical user interface is further configured to:
display a freeform data field for each of a first group of the selected group of the plurality of publication attributes, wherein any user defined entry may be placed in the data field; and
display a drop down menu for each of a second group of the selected group of the plurality of publication attributes, wherein the dropped down menu contains a plurality of predefined entries for selection.
